(19) United States
(12) Patent Application Publication
(10) Pub. No.: US 2026/0333249 A1
(43) Pub. Date: Oct. 22, 2026

(54) COMMUNICATION METHOD AND APPARATUS

(71) Applicant: HUAWEI TECHNOLOGIES CO., LTD., Shenzhen (CN)

(72) Inventors: Dongdong WEI, Shenzhen (CN); Hao TANG, Shanghai (CN); Liqing ZHANG, Ottawa (CA); Jianglei MA, Ottawa (CA)

(73) Assignee: HUAWEI TECHNOLOGIES CO., LTD., Shenzhen (CN)

(21) Appl. No.: 19/468,611

(22) Filed: Feb. 3, 2026

Related U.S. Application Data
(63) Continuation of application No. PCT/CN2023/115612, filed on Aug. 29, 2023.

(51) Int. Cl. H04W 52/36; H04W 52/24

(52) U.S. Cl. CPC H04W 52/367; H04W 52/24

(57) ABSTRACT

A communication method and apparatus are provided, to determine an appropriate signal transmit power when a terminal cannot determine a path loss. In the method, a compensation coefficient may be determined based on information about a first signal. The information about the first signal may reflect a location relationship between a terminal apparatus and a second access network device. In other words, the compensation coefficient may represent the location relationship between the terminal apparatus and the second access network device. After obtaining the compensation coefficient, the terminal apparatus may determine a transmit power of a second signal based on the compensation coefficient and a maximum transmit power of the terminal apparatus, or may determine a transmit power of a second signal based on a transmit power expected by the second access network device, the compensation coefficient, and a path loss between the terminal apparatus and a first access network device.

### CROSS-REFERENCE TO RELATED APPLICATIONS

This application is a continuation of International Application No. PCT/CN2023/115612, filed on Aug. 29, 2023, the disclosure of which is hereby incorporated by reference in its entirety.

### TECHNICAL FIELD

The embodiments relate to the communication field, for example, to a communication method and apparatus.

### BACKGROUND

In a propagation process, a signal is affected by a path loss and shadow fading, causing signal strength to decrease when the signal reaches a receive end. Therefore, a transmit end appropriately adjusts a transmit power, to compensate for impact of the path loss and the shadow fading. For example, for an uplink carrier of a cell, a transmit power of a terminal may be a sum of open-loop power control, closed-loop power control, and another adjustment amount. The open-loop power control is related to a radio resource control (RRC) higher-layer parameter configuration and partial path loss compensation, the closed-loop power control is related to a historical transmit power, and another adjustment amount is related to frequency domain resource allocation and link adaptation. In a scenario in which the terminal has no historical transmit power information, an open-loop power control manner may be used. For example, in this case, the transmit power of the terminal may be a sum of a higher-layer configured target receive power of a base station and a path loss between the terminal and the base station. The path loss may be determined based on a transmit power of the base station and a receive power of a signal received by the terminal. The transmit power of the base station may be obtained by using system information broadcast by the base station.

However, in some scenarios, for example, in a scenario in which the base station does not broadcast the system information carrying the transmit power of the base station, the terminal apparatus cannot determine the path loss between the terminal apparatus and the base station. In this case, to ensure that the receive end can receive the signal, the terminal apparatus may transmit the signal by using a maximum transmit power. However, this causes unnecessary energy consumption, and is not conducive to energy saving of the terminal. Therefore, how to determine an appropriate signal transmit power when the terminal apparatus cannot determine a path loss between the terminal apparatus and an access network device is an urgent problem to be resolved.

### SUMMARY

Embodiments provide a communication method and apparatus, to determine an appropriate signal transmit power when a terminal apparatus cannot determine a path loss between the terminal apparatus and an access network device.

To achieve the foregoing objective, the embodiments use the following solutions.

According to a first aspect, a communication method is provided. The method includes: obtaining a compensation coefficient; and sending a second signal to a second access network device based on the compensation coefficient, where the compensation coefficient is determined based on information about a first signal sent by a first access network device, the information about the first signal includes at least one of the following: a receive power of the first signal or an index corresponding to the first signal, and a transmit power of the second signal is determined based on the compensation coefficient.

Therefore, because the receive power of the first signal and/or the index corresponding to the first signal may reflect a location relationship between a terminal apparatus and the second access network device, and the compensation coefficient may be determined based on the receive power of the first signal and/or the index corresponding to the first signal, it may be understood that the compensation coefficient may represent the location relationship between the terminal apparatus and the second access network device. After obtaining the compensation coefficient, the terminal apparatus may determine the transmit power of the second signal based on the compensation coefficient and a maximum transmit power of the terminal apparatus, or may determine the transmit power of the second signal based on a transmit power expected by the second access network device, the compensation coefficient, and a path loss between the terminal apparatus and the first access network device. In this way, an appropriate transmit power of the second signal may be determined based on the compensation coefficient that can reflect the location relationship between the terminal apparatus and the second access network device.

The compensation coefficient may represent the location relationship between the terminal apparatus and the second access network device. When the first access network device and the second access network device are a same device, the terminal apparatus cannot obtain the path loss between the terminal apparatus and the first access network device. In this case, a larger receive power of the first signal may indicate a stronger radio signal, and a shorter distance between the terminal apparatus and the first access network device. In this case, the compensation coefficient is also smaller. When the first access network device and the second access network device are different devices, the terminal apparatus cannot obtain a path loss between the terminal apparatus and the second access network device. In this case, the index corresponding to the first signal may reflect an orientation of the terminal apparatus, or the receive power of the first signal and the index corresponding to the first signal may reflect an approximate location of the terminal apparatus, so that the location relationship between the terminal apparatus and the second access network device can be determined, and the location relationship is represented based on the compensation coefficient, for example, a closer distance between the terminal apparatus and the second access network device indicates a smaller compensation coefficient.

In a possible embodiment, the transmit power of the second signal is determined based on the maximum transmit power of the terminal apparatus and the compensation coefficient. For example, the transmit power of the second signal may be a product of the maximum transmit power and the compensation coefficient, and the product is less than or equal to the maximum transmit power of the terminal apparatus. In this way, when the terminal apparatus cannot obtain the path loss between the terminal apparatus and the second access network device and the transmit power expected by the second access network device, the terminal apparatus can determine the appropriate transmit power of the second signal based on the maximum transmit power of the terminal apparatus and the compensation coefficient.

Optionally, the transmit power of the second signal is determined based on the maximum transmit power of the terminal apparatus, the compensation coefficient, and a power boost step or operation, or the transmit power of the second signal is determined based on the maximum transmit power of the terminal apparatus, the compensation coefficient, and a first power offset, or the transmit power of the second signal is determined based on the maximum transmit power of the terminal apparatus, the compensation coefficient, a power boost step or operation, and a first power offset; and the power boost step or operation is a power increased during retransmission of the second signal, and the first power offset is determined based on service information of the terminal apparatus. In other words, the transmit power of the second signal may be determined based on the maximum transmit power of the terminal apparatus and the compensation coefficient, and may be further determined by selecting the power boost step or operation and/or the first power offset based on a situation. For example, when the second signal is a retransmitted signal, to improve a possibility that the second access network device successfully receives the second signal, the transmit power of the second signal may be determined with reference to the power boost step or operation. For another example, when the terminal apparatus has a service to be sent, a function of the second signal may be waking up the second access network device in a sleep state, or requesting the second access network device to deliver system information. To improve a possibility that the second access network device successfully receives the second signal, the transmit power of the second signal may be determined with reference to a first power offset corresponding to service information of the service. In this way, a more appropriate transmit power of the second signal may be determined based on a situation.

Further, the transmit power of the second signal is expressed as P=min{P_{CMAX}, α₁·P_{CMAX}+Δ₁+Δ₂}, where P is the transmit power of the second signal, P_{CMAX} is the maximum transmit power of the terminal apparatus, α₁ is the compensation coefficient, Δ₁ is the power boost step or operation, Δ₂ is the first power offset, and min{P_{CMAX},α₁·P_{CMAX}+Δ₁+Δ₂} represents selecting a smaller value from P_{CMAX} and α₁·P_{CMAX}+Δ₁+Δ₂. In other words, after determining an expected uplink transmit power based on the maximum transmit power of the terminal apparatus, the compensation coefficient, the power boost step or operation, and the first power offset, the terminal apparatus may compare the expected uplink transmit power with the maximum transmit power of the terminal apparatus, and select a smaller value of the two as the transmit power of the second signal. In this way, it may be ensured that the transmit power of the second signal is less than or equal to the maximum transmit power of the terminal apparatus, to ensure that the terminal apparatus successfully sends the second signal.

In a possible embodiment, the transmit power of the second signal is determined based on a signal receive power expected by the second access network device, a path loss (denoted as a path loss #1) between a terminal apparatus and the first access network device, and the compensation coefficient. It may be understood that a product of the path loss #1 and the compensation coefficient may be used as a path loss (denoted as a path loss #2) between the terminal apparatus and the second access network device. Therefore, the transmit power of the second signal may be determined by adding the path loss #2 to the signal receive power expected by the second access network device. In this way, when the terminal apparatus can obtain the signal receive power expected by the second access network device, but cannot obtain the path loss between the terminal apparatus and the second access network device, the terminal apparatus may determine an appropriate transmit power of the second signal in this manner.

Optionally, the transmit power of the second signal is determined based on the signal receive power expected by the second access network device, the path loss, the compensation coefficient, and a power boost step or operation, or the transmit power of the second signal determined based on the signal receive power expected by the second access network device, the path loss, the compensation coefficient, and a first power offset, or the transmit power of the second signal determined based on the signal receive power expected by the second access network device, the path loss, the compensation coefficient, and a first adjustment amount, or the transmit power of the second signal determined based on the signal receive power expected by the second access network device, the path loss, the compensation coefficient, a power boost step or operation, and a first power offset, or the transmit power of the second signal determined based on the signal receive power expected by the second access network device, the path loss, the compensation coefficient, a power boost step or operation, and a first adjustment amount, or the transmit power of the second signal determined based on the signal receive power expected by the second access network device, the path loss, the compensation coefficient, a first power offset, and a first adjustment amount, or the transmit power of the second signal determined based on the signal receive power expected by the second access network device, the path loss, the compensation coefficient, a power boost step or operation, a first power offset, and a first adjustment amount; and the power boost step or operation is a power increased during retransmission of the second signal, the first power offset is determined based on service information of the terminal apparatus, and the first adjustment amount is a power adjustment amount related to frequency domain resource allocation and link adaptation that correspond to the second signal.

In other words, the transmit power of the second signal may be determined based on the signal receive power expected by the second access network device, the path loss, and the compensation coefficient, and may be further determined by selecting at least one of the following items: the power boost step or operation, the first power offset, or the first adjustment amount based on a situation. For example, when the second signal is a retransmitted signal, to improve a possibility that the second access network device successfully receives the second signal, the transmit power of the second signal may be determined with reference to the power boost step or operation. For another example, when the terminal apparatus has a service to be sent, a function of the second signal may be waking up the second access network device in a sleep state, or requesting the second access network device to deliver system information. To improve a possibility that the second access network device successfully receives the second signal, the transmit power of the second signal may be determined with reference to the first power offset. For another example, to improve a possibility that the second access network device successfully receives the second signal, the transmit power of the second signal may be alternatively determined with reference to the first adjustment amount. In this way, a more appropriate transmit power of the second signal may be determined based on a situation.

Further, the transmit power of the second signal is expressed as P=min{P_{CMAX},Pₑ+α₂·PL+Δ₁}, where P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step or operation, and min{P_{CMAX},Pₑ+α₂·PL+Δ₁} represents selecting a smaller value from P_{CMAX} and Pₑ+α₂·PL+Δ₁. In other words, after determining an expected uplink transmit power based on the signal receive power expected by the second access network device, the path loss, the compensation coefficient, and the power boost step or operation, the terminal apparatus may compare the expected uplink transmit power with the maximum transmit power of the terminal apparatus, and select a smaller value of the two as the transmit power of the second signal. In this way, it may be ensured that the transmit power of the second signal is less than or equal to the maximum transmit power of the terminal apparatus, to ensure that the terminal apparatus successfully sends the second signal.

Further, the transmit power of the second signal is expressed as P=min{P_{CMAX},Pₑ+α₂·PL+Δ₁+Δ₂+10 log₁₀(2^{μ}·M_{RB})}, where P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step or operation, Δ₂ is the first power offset, 10 log₁₀(2^{μ}·M_{RB}) is the first adjustment amount, μ corresponds to a subcarrier spacing used for transmitting the second signal, M_{RB} is a quantity of resource blocks (RBs) occupied for transmitting the second signal, and min{P_{CMAX},Pₑ+α₂·PL+Δ₁+Δ₂+10 log₁₀(2^{μ}·M_{RB})} represents selecting a smaller value from P_{CMAX} and Pₑ+α₂·PL+Δ₁+Δ₂+10 log₁₀(2^{μ}·M_{RB}). In other words, after determining an expected uplink transmit power based on the signal receive power expected by the second access network device, the path loss, the compensation coefficient, the power boost step or operation, the first power offset, and the first adjustment amount, the terminal apparatus may compare the expected uplink transmit power with the maximum transmit power of the terminal apparatus, and select a smaller value of the two as the transmit power of the second signal. In this way, it may be ensured that the transmit power of the second signal is less than or equal to the maximum transmit power of the terminal apparatus, to ensure that the terminal apparatus successfully sends the second signal.

Further, the first power offset is determined based on a first correspondence between the service information of the terminal apparatus and a value of the first power offset. In this way, the terminal apparatus may quickly and accurately determine the first power offset based on the service information and the first correspondence.

Further, the first correspondence is from the first access network device, and the first correspondence is carried in at least one of the following messages: system information, a synchronization signal, or a radio resource control RRC message; or the first correspondence is protocol-predefined. In other words, a manner of obtaining the first correspondence may be flexibly set based on a situation.

In a possible embodiment, obtaining the compensation coefficient includes: determining the compensation coefficient based on a second correspondence and the information about the first signal, where the second correspondence is a correspondence between a value range of the receive power of the first signal and a value of the compensation coefficient, or the second correspondence is a correspondence between the index corresponding to the first signal and a value of the compensation coefficient, or the second correspondence is a correspondence between a value range of the receive power of the first signal, the index corresponding to the first signal, and a value of the compensation coefficient. In this way, the terminal apparatus may quickly and accurately determine the compensation coefficient based on the second correspondence and the information about the first signal.

Optionally, the second correspondence is from the first access network device, and the second correspondence is carried in at least one of the following messages: the system information, the synchronization signal, or the RRC message; or the second correspondence is protocol-predefined. In other words, a manner of obtaining the second correspondence may be flexibly set based on a situation.

In a possible embodiment, the first access network device and the second access network device are a same device, and obtaining the compensation coefficient includes: receiving a secondary synchronization signal SSS sent by the first access network device; and determining the compensation coefficient based on a signal receive power of the SSS. In other words, when the signal periodically sent by the first access network device does not include the system information, the terminal apparatus may receive the SSS, and determine the compensation coefficient based on the signal receive power of the SSS, to determine the transmit power of the second signal.

Optionally, the second signal is used to request the first access network device to send the system information, and the method according to the first aspect further includes: receiving the system information sent by the first access network device.

In a possible embodiment, the first access network device and the second access network device are a same device, and the value of the compensation coefficient is inversely correlated with a value of the receive power of the first signal. For example, a larger receive power of the first signal indicates a stronger radio signal, and a shorter distance between the terminal apparatus and the first access network device. In this case, the compensation coefficient is smaller.

In a possible embodiment, a cell of the first access network device and a cell of the second access network device are neighboring cells of each other, or the first access network device is a macro base station and the second access network device is a micro base station of the macro base station; and obtaining the compensation coefficient includes: receiving an SSS of the first access network device; and determining the compensation coefficient based on a signal receive power of the SSS and an index corresponding to the SSS, or an index corresponding to the SSS. In other words, when the second access network device is in a sleep state, or the second access network device is used as a micro base station and is downlink disabled, the terminal apparatus may receive the SSS, and determine the compensation coefficient based on the signal receive power of the SSS and the index corresponding to the SSS, or the index corresponding to the SSS, to determine the transmit power of the second signal.

In a possible embodiment, the transmit power of the second signal is less than or equal to the maximum transmit power of the terminal apparatus. For example, the transmit power, of the second signal, determined by the terminal apparatus is not greater than the maximum transmit power, so that it can be ensured that the terminal apparatus successfully sends the second signal.

According to a second aspect, a communication method is provided. The method includes: obtaining a second correspondence, and sending the second correspondence, where the second correspondence indicates a correspondence between a receive power of a first signal and a value of a compensation coefficient, or the second correspondence indicates a correspondence between an index corresponding to a first signal and a value of a compensation coefficient, or the second correspondence indicates a correspondence between a receive power of a first signal, an index corresponding to the first signal, and a value of a compensation coefficient.

It may be understood from the method according to the second aspect that a first access network device sends the second correspondence, so that a terminal apparatus can determine the compensation coefficient based on the second correspondence and information about the received first signal. The compensation coefficient may be determined based on the receive power of the first signal and/or the index corresponding to the first signal. The receive power of the first signal and/or the index corresponding to the first signal may reflect a location relationship between the terminal apparatus and a second access network device. In other words, the compensation coefficient may represent the location relationship between the terminal apparatus and the second access network device. For example, when the first access network device and the second access network device are a same device, a larger receive power of the first signal may indicate a stronger radio signal, and a shorter distance between the terminal apparatus and the first access network device. In this case, the compensation coefficient is also smaller. For another example, when the first access network device and the second access network device are different devices, the index corresponding to the first signal may reflect an orientation of the terminal apparatus, or the receive power of the first signal and the index corresponding to the first signal may reflect an approximate location of the terminal apparatus, so that the location relationship between the terminal apparatus and the second access network device can be determined, and the location relationship is represented based on the compensation coefficient, for example, a closer distance between the terminal apparatus and the second access network device indicates a smaller compensation coefficient. After obtaining the compensation coefficient, the terminal apparatus may determine a transmit power of a second signal based on the compensation coefficient and a maximum transmit power of the terminal apparatus, or may determine a transmit power of a second signal based on a transmit power expected by the second access network device, the compensation coefficient, and a path loss between the terminal apparatus and the first access network device. In this way, an appropriate transmit power of the second signal may be determined based on the compensation coefficient that can reflect the location relationship between the terminal apparatus and the second access network device.

In a possible embodiment, the method according to the second aspect further includes: sending a first correspondence, where the first correspondence indicates a correspondence between service information of the terminal apparatus and a value of a first power offset. For example, after receiving the first correspondence, the terminal apparatus may quickly and accurately determine a first power offset based on the service information of the terminal apparatus and the first correspondence.

In addition, for effect of the method according to the second aspect, refer to the effect of the method according to the first aspect. Details are not described herein again.

According to a third aspect, a communication apparatus is provided. The communication apparatus includes modules configured to perform the method according to the first aspect, for example, a transceiver module and a processing module. For example, the processing module is configured to obtain a compensation coefficient, where the compensation coefficient is determined based on information about a first signal sent by a first access network device, and the information about the first signal includes at least one of the following: a receive power of the first signal or an index corresponding to the first signal; and the transceiver module is configured to send a second signal to a second access network device based on the compensation coefficient, where a transmit power of the second signal is determined based on the compensation coefficient.

Optionally, the transceiver module may include a sending module and a receiving module. The sending module is configured to implement a sending function of the communication apparatus according to the third aspect, and the receiving module is configured to implement a receiving function of the communication apparatus according to the third aspect.

Optionally, the communication apparatus according to the third aspect may further include a storage module. The storage module stores a program or instructions. When the processing module executes the program or the instructions, the communication apparatus is enabled to perform the method according to the first aspect.

It may be understood that the communication apparatus according to the third aspect may be a terminal or a network apparatus, for example, a remote device, or may be a chip (system) or another part or component that may be disposed in a terminal or a network apparatus, or may be an apparatus that includes a terminal or a network apparatus. This is not limited.

In addition, for effect of the communication apparatus according to the third aspect, refer to the effect of the method according to the first aspect. Details are not described herein again. According to a fourth aspect, a communication apparatus is provided. The communication apparatus includes modules configured to perform the method according to the second aspect, for example, a transceiver module and a processing module. For example, the processing module is configured to obtain a second correspondence, where the second correspondence indicates a correspondence between a signal receive power and a value of a compensation coefficient, or the second correspondence indicates a correspondence between an index corresponding to a signal and a value of a compensation coefficient, or the second correspondence indicates a correspondence between a signal receive power, an index corresponding to a signal, and a compensation coefficient; and the transceiver module is configured to send the second correspondence.

Optionally, the transceiver module may include a sending module and a receiving module. The sending module is configured to implement a sending function of the communication apparatus according to the fourth aspect, and the receiving module is configured to implement a receiving function of the communication apparatus according to the fourth aspect.

Optionally, the communication apparatus according to the fourth aspect may further include a storage module. The storage module stores a program or instructions. When the processing module executes the program or the instructions, the communication apparatus is enabled to perform the method according to the second aspect.

It may be understood that the communication apparatus according to the fourth aspect may be a terminal or a network apparatus, for example, a remote device, or may be a chip (system) or another part or component that may be disposed in a terminal or a network apparatus, or may be an apparatus that includes a terminal or a network apparatus. This is not limited.

In addition, for effect of the communication apparatus according to the fourth aspect, refer to the effect of the method according to the second aspect. Details are not described herein again.

According to a fifth aspect, a communication apparatus is provided. The communication apparatus includes a processor. The processor is configured to perform the method according to any one of the possible embodiments of the first aspect or the second aspect.

In a possible embodiment, the communication apparatus according to the fifth aspect may further include a transceiver. The transceiver may be a transceiver circuit or an interface circuit. The transceiver may be used by the communication apparatus according to the fifth aspect to communicate with another communication apparatus.

In a possible embodiment, the communication apparatus according to the fifth aspect may further include a memory. The memory may be integrated with the processor, or may be disposed separately from the processor. The memory may be configured to store a computer program and/or data related to the method according to any one of the first aspect or the second aspect.

In this embodiment, the communication apparatus according to the fifth aspect may be the terminal or the network apparatus according to any one of the first aspect or the second aspect, or a chip (system) or another part or component that may be disposed in the terminal or the network apparatus, or an apparatus that includes the terminal or the network apparatus.

In addition, for effect of the communication apparatus according to the fifth aspect, refer to the effect of the method according to any one of the possible embodiments of the first aspect or the second aspect. Details are not described herein again.

According to a sixth aspect, a communication apparatus is provided. The communication apparatus includes a processor. The processor is coupled to a memory, and the processor is configured to execute a computer program stored in the memory, so that the communication apparatus performs the method according to any one of the possible embodiments of the first aspect or the second aspect.

In a possible embodiment, the communication apparatus according to the sixth aspect may further include a transceiver. The transceiver may be a transceiver circuit or an interface circuit. The transceiver may be used by the communication apparatus according to the sixth aspect to communicate with another communication apparatus.

In this embodiment, the communication apparatus according to the sixth aspect may be the terminal or the network apparatus according to any one of the first aspect or the second aspect, or a chip (system) or another part or component that may be disposed in the terminal or the network apparatus, or an apparatus that includes the terminal or the network apparatus.

In addition, for effect of the communication apparatus according to the sixth aspect, refer to the effect of the method according to any one of the possible embodiments of the first aspect or the second aspect. Details are not described herein again.

According to a seventh aspect, a communication apparatus is provided. The communication apparatus includes a processor and a memory. The memory is configured to store a computer program; and when the processor executes the computer program, the communication apparatus is enabled to perform the method according to any one of the embodiments of the first aspect or the second aspect.

In a possible embodiment, the communication apparatus according to the seventh aspect may further include a transceiver. The transceiver may be a transceiver circuit or an interface circuit. The transceiver may be used by the communication apparatus according to the seventh aspect to communicate with another communication apparatus.

In this embodiment, the communication apparatus according to the seventh aspect may be the terminal or the network apparatus according to any one of the first aspect or the second aspect, or a chip (system) or another part or component that may be disposed in the terminal or the network apparatus, or an apparatus that includes the terminal or the network apparatus.

In addition, for effect of the communication apparatus according to the seventh aspect, refer to the effect of the method according to any one of the possible embodiments of the first aspect or the second aspect. Details are not described herein again.

According to an eighth aspect, a communication apparatus is provided. The communication apparatus may be a first apparatus, or may be a module or unit (for example, a chip, a chip system, or a circuit) that is in the first apparatus and that one-to-one correspondingly performs the method/operation/step/action described in the first aspect, or can be used in a matching manner with the first apparatus.

According to a ninth aspect, a communication apparatus is provided. The communication apparatus may be a second apparatus, or may be a module or unit (for example, a chip, a chip system, or a circuit) that is in the second apparatus and that one-to-one correspondingly performs the method/operation/step/action described in the second aspect, or can be used in a matching manner with the second apparatus.

According to a tenth aspect, a communication chip is provided. The communication chip stores instructions; and when the chip runs on a communication device, the method according to any one of the embodiments of the first aspect or the second aspect is implemented.

According to an eleventh aspect, a communication chip is provided. The communication chip includes a logic circuit and a communication interface. The logic circuit is configured to execute computer instructions, and the communication interface is configured to communicate with another apparatus or chip; and when the logic circuit executes the computer instructions, the method according to any one of the embodiments of the first aspect or the second aspect is implemented.

According to a twelfth aspect, a communication system is provided. The communication system includes an apparatus configured to perform the method according to the first aspect and/or an apparatus configured to perform the method according to the second aspect.

According to a thirteenth aspect, a non-transitory computer-readable storage medium is provided. The non-transitory computer-readable storage medium includes a computer program or instructions; and when the computer program or the instructions are run on a computer, the computer is enabled to perform the method according to any one of the possible embodiments of the first aspect or the second aspect.

According to a fourteenth aspect, a computer program product is provided. The computer program product includes a computer program or instructions; and when the computer program or the instructions are run on a computer, the computer is enabled to perform the method according to any one of the possible embodiments of the first aspect or the second aspect.

### BRIEF DESCRIPTION OF DRAWINGS

FIG. 1 is a diagram of a macro-micro scenario according to an embodiment;

FIG. 2 is a diagram 1 of an architecture of a communication system according to an embodiment;

FIG. 3 is a diagram 2 of an architecture of a communication system according to an embodiment;

FIG. 4 is a schematic flowchart of a communication method according to an embodiment;

FIG. 5 is a diagram of a correspondence between a range of a signal receive power of a first access network device and a value of a compensation coefficient according to an embodiment;

FIG. 6 is a diagram 1 of locations of a first access network device, a second access network device, and a terminal apparatus according to an embodiment;

FIG. 7 is a diagram 1 of locations of a first access network device and a second access network device according to an embodiment;

FIG. 8 is a diagram 2 of locations of a first access network device and a second access network device according to an embodiment;

FIG. 9 is a diagram 2 of locations of a first access network device, a second access network device, and a terminal apparatus according to an embodiment;

FIG. 10 is a diagram 1 of a structure of a communication apparatus according to an embodiment; and

FIG. 11 is a diagram 2 of a structure of a communication apparatus according to an embodiment.

### DETAILED DESCRIPTION OF EMBODIMENTS

For ease of understanding, the following first describes terms in embodiments.

### 1. Uplink Power Control Mechanism

In a communication system, for example, a 5G new radio (New RAT, NR) system, an uplink channel and a signal include a physical random access channel (PRACH), a physical uplink shared channel (PUSCH), a physical uplink control channel (PUCCH), and a channel sounding reference signal (SRS), and a protocol separately defines related power adjustment formulas for the uplink channel and the signal. For different channels and signals, power calculation manners are different, but comply with a large basic framework. For example, a base station side calculates a transmit power control (TPC) command of a terminal apparatus based on a power control configuration parameter, terminal apparatus feedback information, base station measurement information, and the like, and delivers the TPC to the terminal apparatus by using downlink control information (DCI) of a physical downlink control channel (PDCCH); and the terminal apparatus maps the TPC to a power adjustment amount, and determines a next uplink transmit power based on information such as a maximum transmit power of the terminal apparatus, a path loss (such as, a path loss), a quantity of resource blocks (RB), and a transmission format.

For example, on an uplink carrier of a cell, a transmit power of the terminal apparatus is calculated in the following manner:

P=min{maximum transmit power P_{CMAX} of the terminal apparatus on the uplink carrier, expected uplink transmit power} (1)

The expected uplink transmit power is a sum of open-loop power control, closed-loop power control, and another adjustment amount. The open-loop power control is related to an RRC higher-layer parameter configuration and partial path loss compensation, and an expression of the open-loop power control is P₀(j)+α(j)*PL(q), where P₀(j) is a target receive power level expected by the base station, α(j) is a partial path loss factor, α(j) is configured by the base station and delivered to the terminal apparatus, and PL is a path loss. The closed-loop power control is related to a historical transmit power, and may be expressed as ƒ(l), where l is an index of a closed-loop power control adjustment amount, and adjustment information (for example, TPC) is indicated by using DCI. Another adjustment amount is related to frequency domain resource allocation and link adaptation, and an expression of the adjustment is 10 lg(2^{μ}*M)+Δ_{TF}, where μ corresponds to a subcarrier spacing used for a current uplink transmission, M is a quantity of RBs allocated for the current uplink transmission, and Δ_{TF} is an adjustment amount related to an uplink transmission format.

It may be understood that the transmit power of the terminal apparatus may also be expressed as: P=min{P_{CMAX}, P₀(j)+α(j)*PL(q)+ƒ(l)+10 lg(2^{μ}*M)+Δ_{TF}}. In other words, after calculating the expected uplink transmit power, the terminal apparatus compares the expected uplink transmit power with the maximum transmit power of the terminal apparatus, and determines a smaller transmit power of the two as a signal transmit power.

In some scenarios, the terminal apparatus has no historical transmit power information. In this case, the expected uplink transmit power of the terminal apparatus may be determined by using the open-loop power control, for example, the uplink transmit power is determined based on information such as a path loss and a power control parameter provided by the base station side.

Power control of the PRACH is used as an example. The base station provides a transmit power of the base station and a PRACH related configuration, for example, an expected preamble receive power level, a maximum quantity of preamble transmissions, or a power boost step or operation, by using a system information block (SIB) 1. The terminal apparatus determines a path loss between the terminal apparatus and the base station based on a received reference signal received power (RSRP) of a physical broadcast channel (PBCH) block (synchronization signal and PBCH block, SSB) and a transmit power, of the base station, broadcast in the SIB 1. A value of the path loss is a value obtained by subtracting the reference signal received power from the signal transmit power of the base station. After determining the path loss, the terminal apparatus may determine a transmit power of the PRACH according to the following formula:

P_{RACH,b,f,c}(i)=min{P_{CMAX,F,c}(i),P_{RACH,target,f,c}+PL_{b,f,c}} (2)

P_{PRACH,target,f,c} is the foregoing target receive power, and PL_{b,f,c} is the path loss between the terminal apparatus and the base station. It may be understood that when the terminal apparatus has no historical transmit power information and uses an open-loop power control manner, α(j) is 1. In other words, in this case, the expected uplink transmit power of the terminal apparatus may be determined based on the target receive power and the path loss.

However, in some scenarios, for example, the following scenario 1 to scenario 3, the terminal apparatus cannot obtain the path loss between the terminal apparatus and the base station.

Scenario 1: a signal periodically broadcast in a cell does not include system information, for example, a SIB 1, for example, the system information is obtained in an on-demand manner. For example, the terminal apparatus may send an uplink wake-up signal (UL WUS) to trigger the base station to send the system information. In this case, for sending the UL WUS, the signal transmit power of the base station cannot be obtained, and consequently the path loss cannot be determined.

Scenario 2: the base station is in a sleep state, and the terminal apparatus wakes up the base station by using a UL WUS. In this case, because the base station is sleep, the SIB 1 is not sent. As a result, before sending the UL WUS, the terminal apparatus cannot obtain the transmit power of the base station, and consequently cannot determine the path loss.

Scenario 3: in a macro-micro scenario, a downlink of a micro base station may be enabled or disabled as required. When the downlink of the micro base station is disabled, the micro base station still receives a random access preamble sent by the terminal apparatus. However, in this case, the terminal apparatus cannot obtain a signal transmit power of the micro base station and cannot receive a downlink signal from the micro base station, and consequently cannot determine the path loss. It may be understood that as shown in FIG. 1, in network deployment, a macro base station provides wide coverage. However, for a hotspot area within the coverage of the macro base station, for example, a scenario such as an office area or a stadium, because there are a large quantity of users, some micro base stations are correspondingly deployed to ensure user experience. Such a scenario is a macro-micro scenario.

It may be understood that in the foregoing scenario 1 to scenario 3, the terminal apparatus cannot obtain the transmit power of the base station or the terminal apparatus cannot receive a downlink signal from the base station, and consequently the terminal apparatus cannot determine the path loss between the terminal apparatus and the base station, for example, the terminal apparatus cannot determine the expected uplink transmit power by using the open-loop power control. To ensure that a receive end can receive a signal, the terminal transmits the signal by using a maximum transmit power. However, this causes unnecessary energy consumption, and is not conducive to energy saving of the terminal. Therefore, how to determine an appropriate signal transmit power when the terminal cannot determine the path loss is an urgent problem to be resolved.

For the foregoing problem, embodiments provide the following solutions, to determine the appropriate signal transmit power when the terminal apparatus cannot determine a path loss between the terminal apparatus and an access network device.

The following describes solutions of the embodiments with reference to accompanying drawings.

The solutions in embodiments may be applied to various communication systems, for example, a 4th generation (4G) mobile communication system such as a long term evolution (LTE) system, a 5th generation (5G) mobile communication system such as a new radio (NR) system, and a communication system evolved after 5G such as a 6th generation (6G) mobile communication system; or may be applied to a wireless fidelity (Wi-Fi) system, a vehicle to everything (V2X) communication system, a device-to-device (D2D) communication system, an internet of vehicles communication system, or the like.

All aspects, embodiments, or features are presented by describing a system that may include a plurality of devices, components, modules, and the like. It should be appreciated and understood that each system may include another device, component, module, and the like, and/or may not include all devices, components, modules, and the like discussed with reference to the accompanying drawings. In addition, a combination of these solutions may be used.

In addition, in embodiments, the terms such as “example” and “for example” are for representing giving an example, an illustration, or a description. Any embodiment or design solution described as an “example” should not be explained as being more preferred or having more advantages than another embodiment or design solution. The term “example” is for presenting a concept in a specific manner.

In embodiments, “information”, “signal”, “message”, “channel”, and “signaling” may be interchangeably used sometimes. It should be noted that meanings expressed by the terms are matchable when differences of the terms are not emphasized. The terms “of”, “corresponding, relevant”, and “corresponding” may be interchangeably used sometimes. It should be noted that meanings expressed by the terms are matchable when differences of the terms are not emphasized. In addition, “/” mentioned in the embodiments may represent an “or” relationship.

In embodiments, sometimes a subscript, for example, W₁, may be written incorrectly in a non-subscript form, for example, W1. Expressed meanings are consistent when differences are not emphasized.

The network architecture and the service scenario described in embodiments are intended to describe the solutions in embodiments more clearly, and do not constitute a limitation on the solutions provided in embodiments. A person of ordinary skill in the art may know that: with the evolution of the network architecture and the emergence of new service scenarios, the solutions provided in embodiments are also applicable to similar problems.

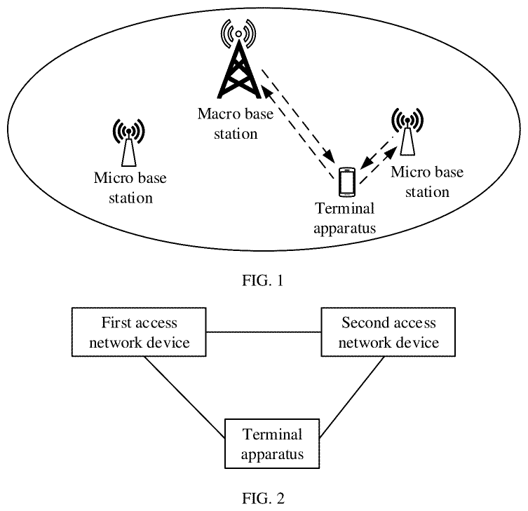

For ease of understanding embodiments, a communication system shown in FIG. 2 is first used as an example to describe in detail a communication system applicable to embodiments. For example, FIG. 2 is a diagram of an architecture of a communication system to which a communication method according to an embodiment is applicable.

As shown in FIG. 2, the communication system includes a terminal apparatus, a first access network device, and a second access network device. The first access network device and the second access network device may be a same device, or may be different devices. This is not limited. When the first access network device and the second access network device are different devices, a cell of the first access network device and a cell of the second access network device may be neighboring cells of each other, or the first access network device is a macro base station and the second access network device is a micro base station of the macro base station. For the terminal apparatus, refer to related descriptions of the following “terminal 120”. For the first access network device and the second access network device, refer to related descriptions of the following “network apparatus 110”. Details are not described herein again.

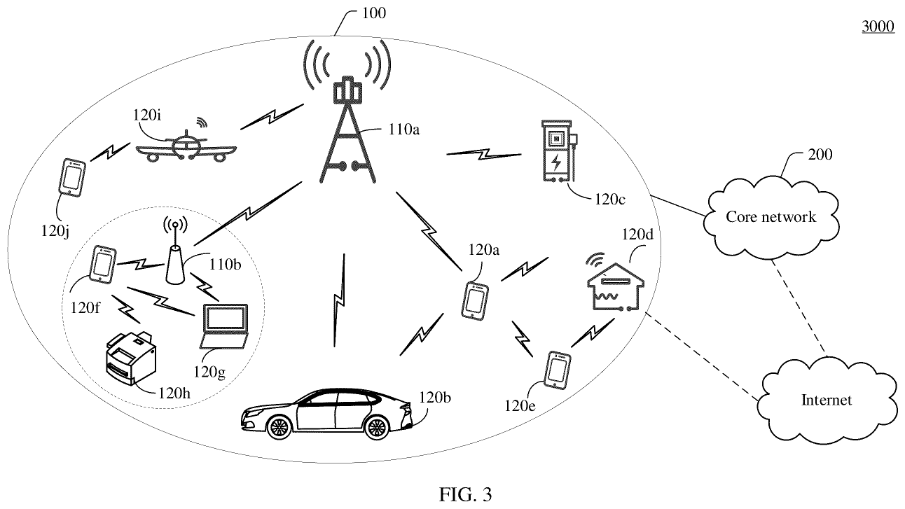

For ease of understanding embodiments, an application scenario used in the embodiments is described by using an architecture of a communication system shown in FIG. 3 as an example. FIG. 3 is a diagram of a possible and non-limiting system. As shown in FIG. 3, the communication system 3000 includes a radio access network (RAN) 100 and a core network (CN) 200. The RAN 100 includes at least one network apparatus (for example, 110a and 110b in FIG. 3, which are collectively referred to as 110) and at least one terminal (for example, 120a to 120j in FIG. 3, which are collectively referred to as 120). The RAN 100 may further include another RAN node, for example, a wireless relay device and/or a wireless backhaul device (not shown in FIG. 3). The terminal 120 is connected to the network apparatus 110 in a wireless manner. The network apparatus 110 is connected to the core network 200 in a wireless or wired manner. A core network device in the core network 200 and the network apparatus 110 in the RAN 100 may be different physical devices, or may be a same physical device that integrates a logical function of the core network and a logical function of the radio access network.

The RAN 100 may be a cellular system related to the 3rd generation partnership project (3GPP), for example, a 4G mobile communication system, a 5G mobile communication system, or a system evolved after 5G (for example, a 6G mobile communication system). The RAN 100 may alternatively be an open access network (O-RAN or ORAN), a cloud radio access network (CRAN), or a Wi-Fi system. The RAN 100 may alternatively be a communication system that integrates two or more of the foregoing systems.

The terminal apparatus and the network apparatus provided in embodiments may be applied to the network apparatus 110, or may be applied to the terminal 120. It may be understood that FIG. 3 shows only one possible architecture of the communication system to which embodiments may be applied. In another possible scenario, the architecture of the communication system may alternatively include another device.

The network apparatus 110 is a node in a radio access network (RAN), and may also be referred to as an access network device or a RAN node (or device). The network apparatus 110 is configured to help the terminal implement wireless access. A plurality of network apparatuses 110 in the communication system 3000 may be nodes of a same type, or may be nodes of different types. In some scenarios, roles of the network apparatus 110 and the terminal 120 are relative. For example, the network element 120i in FIG. 3 may be a helicopter or an uncrewed aerial vehicle, and may be configured as a mobile base station. For the terminal 120j that accesses the RAN 100 through the network element 120i, the network element 120i is a base station. However, for the base station 110a, the network element 120i is a terminal. The network apparatus 110 and the terminal 120 are sometimes referred to as communication apparatuses. For example, the network elements 110a and 110b in FIG. 3 may be understood as communication apparatuses having a base station function, and the network elements 120a to 120j may be understood as communication apparatuses having a terminal function.

In a possible scenario, the network apparatus may be a base station, an evolved NodeB (eNodeB), a transmission reception point (TRP), a transmission point (TP), a next generation NodeB (gNB), a next generation base station in a 6th generation (6G) mobile communication system, a base station in a future mobile communication system, a satellite, an access point (AP) in a Wi-Fi system, for example, a home gateway, a router, a server, a switch, or a bridge, an integrated access and backhaul (IAB) node, a network apparatus in a mobile switching center non-terrestrial network (NTN) communication system, for example, may be deployed on a high-altitude platform or a satellite, or the like. The network apparatus may be a macro base station (for example, 110a in FIG. 3), a micro base station or an indoor station (for example, 110b in FIG. 3), a relay node or a donor node, or a radio controller in a CRAN scenario. Alternatively, the network apparatus may be a device that undertakes a function of a base station in device-to-device (D2D) communication, internet of vehicles communication, uncrewed aerial vehicle communication, or machine-to-machine communication. Optionally, the network apparatus may be a server, a wearable device, a vehicle, a vehicle-mounted device, or the like. For example, an access network device in a vehicle to everything (V2X) technology may be a road side unit (RSU).

In another possible scenario, a plurality of network apparatuses cooperate to assist the terminal in implementing wireless access, and different network apparatuses respectively implement some functions of the base station. For example, the network apparatus may be a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network apparatus may be a CU node, a DU node, or a device including a CU node and a DU node. In addition, the CU may be classified as a network apparatus in an access network RAN, or the CU may be classified as a network apparatus in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in the embodiments. Any one of the CU (or the CU-CP or the CU-UP), the DU, and the RU in the embodiments may be implemented through a software module, a hardware module, or a combination of a software module and a hardware module.

In embodiments, a form of the network apparatus is not limited. An apparatus configured to implement a function of the network apparatus may be a network apparatus, or may be an apparatus, for example, a chip system, that can support the network apparatus in implementing the function. The apparatus may be installed in the network apparatus or used in a matching manner with the network apparatus.

The terminal 120 may also be referred to as a user equipment (UE), a mobile station (MS), a mobile terminal (MT), a user apparatus, an access terminal, a subscriber unit, a subscriber station, a mobile station, a remote station, a remote terminal, a mobile device, a user terminal, a terminal device, a wireless communication device, a user agent, a user apparatus, or the like, or may be a device configured to provide voice or data connectivity for a user, or may be an internet of things device. For example, the terminal device includes a handheld device, a vehicle-mounted device, or the like that has a wireless connection function. Currently, the terminal may be a mobile phone, a tablet computer (Pad), a computer having a wireless transceiver function, a notebook computer, a palmtop computer, a mobile internet device (MID), a wearable device (for example, a smartwatch, a smart band, or a pedometer), a vehicle-mounted device (for example, a car, a bicycle, an electric vehicle, an airplane, a ship, a train, or a high-speed rail), a satellite terminal, a virtual reality (VR) device, an augmented reality (AR) device, a smart point of sale (POS) machine, a customer-premises equipment (CPE), a wireless terminal in industrial control, a smart home device (for example, a refrigerator, a television, an air conditioner, or an electric meter), a smart robot, a robot arm, a workshop device, a wireless terminal in self-driving, a wireless terminal in telemedicine, a wireless terminal in a smart grid, a wireless terminal in transportation safety, a wireless terminal in a smart city, a wireless terminal in a smart home, a flight device (for example, a smart robot, a hot air balloon, an uncrewed aerial vehicle, or an airplane), or the like. The terminal device may alternatively be another device having a function of the terminal. For example, the terminal device may alternatively be a device that undertakes a function of the terminal in D2D communication.

In embodiments, a form of the terminal device is not limited. An apparatus configured to implement a function of the terminal device may be a terminal device, or may be an apparatus, for example, a chip system, that can support the terminal device in implementing the function, for example, a chip system. The apparatus may be installed in the terminal device or used in a matching manner with the terminal device. In embodiments, the chip system may include a chip, or may include a chip and another discrete component.

It should be noted that the solutions in embodiments may alternatively be applied to another communication system, and a corresponding name may alternatively be replaced with a name of a corresponding function in another communication system.

In a communication system, when a terminal apparatus cannot obtain a path loss between the terminal apparatus and a second access network device, the terminal apparatus may determine a transmit power of a second signal by using a compensation coefficient. The compensation coefficient may be determined based on information about a first signal. The information about the first signal may reflect a location relationship between the terminal apparatus and the second access network device. In other words, the compensation coefficient may represent the location relationship between the terminal apparatus and the second access network device. For example, when a first access network device and the second access network device are a same device, the terminal apparatus may determine the compensation coefficient based on a receive power of the first signal. For example, a larger signal receive power indicates a shorter distance between the terminal apparatus and the first access network device, and a smaller compensation coefficient. In this case, the terminal apparatus may determine the transmit power of the second signal based on the compensation coefficient and a maximum transmit power of the terminal apparatus. For another example, when the first access network device and the second access network device are different devices, the terminal apparatus may determine the compensation coefficient based on an index corresponding to the first signal, or the index and the receive power of the first signal. In this case, the terminal apparatus may determine the transmit power of the second signal based on the compensation coefficient and the maximum transmit power of the terminal apparatus. Alternatively, because the terminal apparatus may obtain a path loss between the terminal apparatus and the first access network device, and a transmit power expected by the second access network device may be delivered to the terminal apparatus through the first access network device, the terminal apparatus may further determine the transmit power of the second signal based on the transmit power expected by the second access network device, the compensation coefficient, and the path loss between the terminal apparatus and the first access network device. In this way, when the terminal apparatus cannot obtain a path loss between the terminal apparatus and the second access network device, the terminal apparatus can determine an appropriate transmit power of the second signal based on the compensation coefficient.

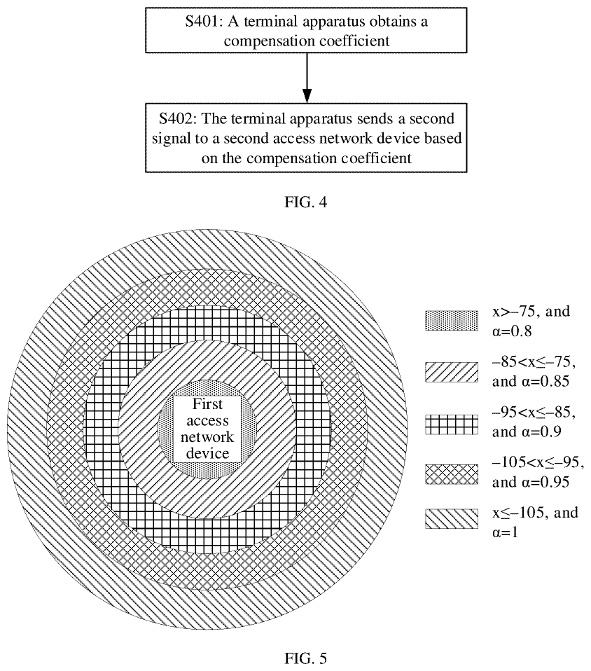

For ease of understanding, the following describes the communication method provided in embodiments with reference to FIG. 4.

For example, FIG. 4 is a schematic flowchart of a communication method according to an embodiment. The method is applicable to communication between the terminal apparatus, the first access network device, and the second access network device in the foregoing communication system.

As shown in FIG. 4, a procedure of the communication method is as follows.

S401: the terminal apparatus obtains a compensation coefficient.

The compensation coefficient is used to obtain a transmit power used by the terminal apparatus to send a second signal (described below). The compensation coefficient may represent a location relationship between the terminal apparatus and the second access network device, and the compensation coefficient may be positively correlated with a distance between the terminal apparatus and the second access network device, for example, a larger distance between the terminal apparatus and the second access network device indicates a larger compensation coefficient.

The compensation coefficient is determined based on information about a first signal sent by the first access network device. In other words, the terminal apparatus may determine the compensation coefficient based on the information about the first signal. The first signal may be a secondary synchronization signal (SSS), or another signal that can be measured by the terminal apparatus. This is not limited. The information about the first signal may include at least one of the following: a receive power of the first signal or an index corresponding to the first signal. In other words, the compensation coefficient may be determined based on the receive power of the first signal, or the index corresponding to the first signal, or the receive power of the first signal and the index corresponding to the first signal. The receive power of the first signal may also be referred to as a reference signal received power (RSRP), and may be obtained by the terminal apparatus by measuring the first signal. A measurement method may reuse a method in the conventional technology. Details are not described herein again. The index corresponding to the first signal is an index of a beam for transmitting the first signal. For a principle of the beam, refer to a principle in the conventional technology. Details are not described herein again.

A manner of determining the compensation coefficient is related to whether the first access network device and the second access network device are a same device. The following provides descriptions in different cases.

Case 1.1: the first access network device and the second access network device are a same device.

In this case, the terminal apparatus may determine the compensation coefficient based on the receive power of the first signal, for example, the compensation coefficient is determined based on the receive power of the first signal.

For example, the terminal apparatus may determine the compensation coefficient based on the receive power of the first signal and a second correspondence, for example, the compensation coefficient is determined based on the receive power of the first signal and the second correspondence. The second correspondence is a correspondence between a value range of the receive power of the first signal and a value of the compensation coefficient. The second correspondence may be preset or protocol-predefined, or may be from the first access network device. In other words, the first access network device may obtain the second correspondence, and send the second correspondence. Correspondingly, the terminal apparatus receives the second correspondence from the first access network device. In this case, the second correspondence may be carried in at least one of the following messages: system information, a synchronization signal, or a radio resource control (RRC) message.

It may be understood that a plurality of different second correspondences may be preset or protocol-predefined; or the first access network device may send a plurality of different second correspondences. The plurality of different second correspondences are a plurality of second correspondences between a plurality of value ranges of the receive power of the first signal and a plurality of values of the compensation coefficient, and the plurality of value ranges are in one-to-one correspondence with the plurality of values. In this case, the terminal apparatus may select, from the plurality of second correspondences based on the value of the receive power of the first signal, a second correspondence corresponding to the value, and then determine the compensation coefficient based on the second correspondence.

For example, as shown in FIG. 5 and Table 1, there are a plurality of second correspondences, such as, different value ranges of the receive power of the first signal correspond to different values of the compensation coefficient. After determining the receive power of the first signal, the terminal apparatus may determine, from the plurality of second correspondences, the second correspondence corresponding to the value of the receive power of the first signal, and then determine, based on the second correspondence, the compensation coefficient corresponding to the receive power of the first signal. It may be understood that the second correspondence shown in Table 1 is an example, and other different second correspondences, for example, a plurality of second correspondences set when value ranges of the receive power of the first signal are set to be smaller, may be set. This is not limited.

TABLE 1

| Receive power x of the first signal | Compensation |
|---|---|
| (decibel milliwatt (dBm)) | coefficient α |
| x > −75 | 0.8 |
| −85 < x ≤ −75 | 0.85 |
| −95 < x ≤ −85 | 0.9 |
| −105 < x ≤ −95 | 0.95 |
| x ≤ −105 | 1 |

For example, if the receive power of the first signal is −100 dBm, as shown in Table 1, −100 dBm is in a range from −105 dBm to −95 dBm, and a compensation coefficient corresponding to the range is 0.95, it may be determined that a value of the compensation coefficient corresponding to −100 dBm is 0.95.

It may be understood that a signal receive power may reflect strength of a radio signal, for example, a larger signal receive power indicates a stronger radio signal. In addition, a distance between the terminal apparatus and the first access network device is positively correlated with the strength of the radio signal, for example, a shorter distance indicates a stronger radio signal. Therefore, a value of the receive power of the first signal may reflect the distance between the terminal apparatus and the first access network device, for example, a larger value of the receive power of the first signal indicates a shorter distance between the terminal apparatus and the first access network device. Because the compensation coefficient is positively correlated with the distance between the terminal apparatus and the first access network device, the value of the compensation coefficient is inversely correlated with the value of the receive power of the first signal, for example, a larger value of the compensation coefficient indicates a smaller receive power of the first signal. In this way, the value of the compensation coefficient may be determined by using the receive power of the first signal and the second correspondence.

In a possible embodiment, that the terminal apparatus obtains the compensation coefficient (S401) may include: the terminal apparatus receives an SSS sent by the first access network device; and the terminal apparatus determines the compensation coefficient based on a signal receive power of the SSS. For an implementation of determining the compensation coefficient based on the signal receive power of the SSS, refer to related descriptions of the foregoing “case 1”. Details are not described herein again.

For example, in the foregoing “scenario 1”, the first access network device may periodically send a synchronization signal, and the synchronization signal includes a primary synchronization signal (PSS) and/or an SSS. Before the terminal apparatus may send a UL WUS to trigger the second access network device to send system information, the terminal apparatus may receive the SSS sent by the first access network device, determine the compensation coefficient based on a signal receive power of the SSS, and then determine a transmit power of the UL WUS based on the compensation coefficient.

Case 1.2: the first access network device and the second access network device are different devices.

In this case, a cell of the first access network device and a cell of the second access network device may be neighboring cells of each other, for example, the first access network device and the second access network device are two neighboring devices; or the first access network device is a macro base station and the second access network device is a micro base station of the macro base station. This is not limited. The terminal apparatus may determine the compensation coefficient based on the index corresponding to the first signal; or the terminal apparatus may determine the compensation coefficient based on the receive power of the first signal and the index corresponding to the first signal, which are separately described below.

Manner 1: the terminal apparatus determines the compensation coefficient based on the index corresponding to the first signal, for example, the compensation coefficient is determined based on the index corresponding to the first signal.

For example, the terminal apparatus may determine the compensation coefficient based on the index corresponding to the first signal and a second correspondence, for example, the compensation coefficient is determined based on the index corresponding to the first signal and the second correspondence. The second correspondence may be a correspondence between the index corresponding to the first signal and a value of the compensation coefficient. For a manner of obtaining the second correspondence, refer to related descriptions in the foregoing “case 1.1”. Details are not described herein again.

It may be understood that a plurality of different second correspondences may be preset or protocol-predefined; or the first access network device may send a plurality of different second correspondences. The plurality of different second correspondences are a plurality of second correspondences between a plurality of indexes corresponding to the first signal and a plurality of values of the compensation coefficient, and the plurality of indexes are in one-to-one correspondence with the plurality of values. The plurality of indexes corresponding to the first signal may be indexes of a plurality of beams for transmitting the first signal. In this case, the terminal apparatus may select, from the plurality of second correspondences based on the index corresponding to the first signal, a second correspondence corresponding to the index, and then determine the compensation coefficient based on the correspondence.

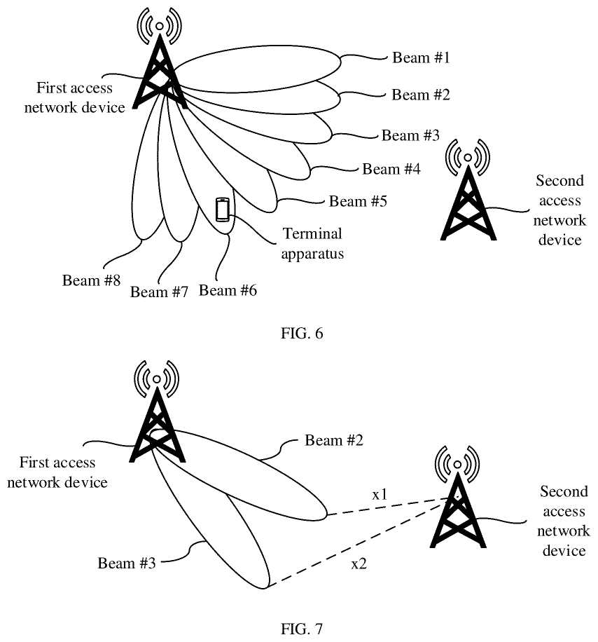

For example, as shown in FIG. 6 and Table 2, there are a plurality of second correspondences, such as, different indexes corresponding to the first signal correspond to different values of the compensation coefficient. After determining the index of the first signal, the terminal apparatus may determine, from the plurality of second correspondences, the second correspondence corresponding to the index, and then determine, based on the second correspondence, the compensation coefficient corresponding to the receive power of the first signal. It may be understood that the second correspondence shown in Table 2 is an example, and a plurality of different second correspondences may be alternatively set based on a situation, for example, a quantity of beams. This is not limited.

TABLE 2

| Index corresponding to the first signal | Compensation coefficient |
|---|---|
| 1 | 0.88 |
| 2 | 0.85 |
| 3 | 0.75 |
| 4 | 0.7 |
| 5 | 0.8 |
| 6 | 0.9 |
| 7 | 0.93 |
| 8 | 0.97 |

For example, if the index corresponding to the first signal is 6, it may be determined, based on the correspondence shown in Table 2, that the compensation coefficient corresponding to the index is 0.9.

It may be understood that as shown in FIG. 6, the first access network device periodically sends signals through a plurality of different beams (for example, a beam #1 to a beam #8 in FIG. 6), and each of the plurality of beams has a unique index. The terminal apparatus may determine a beam (denoted as a beam #a) based on beam measurement, for example, an optimal beam (for example, the beam #6 in FIG. 6), and receive a signal, for example, the first signal, on the beam #a. The beam #a may be a beam with best quality in the plurality of beams. A beam corresponding to beam coverage corresponding to a location of the terminal apparatus may be a beam with best quality in the plurality of beams. For example, in FIG. 6, the terminal apparatus is located within beam coverage of the beam #6, and the beam #6 may be the beam #a obtained by the terminal apparatus through measurement. In other words, coverage of the beam #a obtained by the terminal apparatus through measurement may include the location of the terminal apparatus. Therefore, the index of the beam may reflect an approximate orientation of the terminal apparatus. After the index of the beam for transmitting the first signal is determined, the approximate orientation of the terminal apparatus may be determined, to determine the distance between the terminal apparatus and the second access network device. As shown in FIG. 7, the first access network device in FIG. 7 sends signals through a beam #2 and a beam #3. If the terminal apparatus is located within beam coverage of the beam #2, the distance between the terminal apparatus and the second access network device may be x1. If the terminal apparatus is located within beam coverage of the beam #3, the distance between the terminal apparatus and the second access network device may be x2. It may be understood that the index of the beam for transmitting the first signal may reflect the distance between the terminal apparatus and the second access network device. Because the compensation coefficient is positively correlated with the distance between the terminal apparatus and the second access network device, a correspondence between the index of the beam and the value of the compensation coefficient may be set, and the value of the compensation coefficient is determined by using the index.

It may be further understood that a distance between the second access network device and each beam of the first access network device may be determined in a plurality of manners. For example, the distance is a distance between a location #1 and the second access network device, and the location #1 may be a location, within coverage of the beam, farthest from the first access network device, or the location #1 may be a central location within the coverage of the beam. This is not limited.

In a possible embodiment, that the terminal apparatus obtains the compensation coefficient (S401) may include: the terminal apparatus receives an SSS of the first access network device; and determines the compensation coefficient based on an index corresponding to the SSS. For an implementation of determining the compensation coefficient based on the index corresponding to the SSS, refer to related descriptions of the foregoing “manner 1”. Details are not described herein again.

For example, in the foregoing “scenario 2”, the second access network device is in a sleep state, and a cell of the first access network device and a cell of the second access network device are neighboring cells, or the first access network device is a macro base station and the second access network device is a micro base station of the macro base station. The terminal apparatus may send a UL WUS to wake up the second access network device. Before sending the UL WUS, the terminal apparatus may receive the SSS of the first access network device; and determine the compensation coefficient based on the index corresponding to the SSS, to determine a transmit power of the UL WUS based on the compensation coefficient.

For another example, in the foregoing “scenario 3”, the first access network device is a macro base station, the second access network device is a micro base station of the macro base station, and a downlink of the second access network is disabled. The terminal apparatus may send an uplink preamble signal to access the second access network device. Before sending the uplink preamble signal, the terminal apparatus may receive the SSS of the first access network device; and determine the compensation coefficient based on the index corresponding to the SSS, to determine a transmit power of the uplink preamble signal based on the compensation coefficient.

Manner 2: the terminal apparatus determines the compensation coefficient based on the receive power of the first signal and the index corresponding to the first signal, for example, the compensation coefficient is determined based on the receive power of the first signal and the index corresponding to the first signal.

For example, the terminal apparatus may determine the compensation coefficient based on the receive power of the first signal, the index corresponding to the first signal, and a second correspondence, for example, the compensation coefficient is determined based on the receive power of the first signal, the index corresponding to the first signal, and the second correspondence. The second correspondence is a correspondence between a value range of the receive power of the first signal, the index corresponding to the first signal, and the compensation coefficient. For a manner of obtaining the second correspondence, refer to related descriptions in the foregoing “case 1.1”. Details are not described herein again.

It may be understood that a plurality of different second correspondences may be preset or protocol-predefined; or the first access network device may send a plurality of different second correspondences. The plurality of different second correspondences are N value ranges of the receive power of the first signal, M correspondences between M indexes corresponding to the first signal and M values of the compensation coefficient, each of the N value ranges partially corresponds to the M indexes and the M values, the M indexes are in one-to-one correspondence with the M values, the M indexes may be indexes of M beams for transmitting the first signal, N is an integer greater than 1, and Mis an integer greater than or equal to N. In this case, the terminal apparatus may determine, from the M second correspondences based on the value of the receive power of the first signal and the index corresponding to the first signal, the second correspondence corresponding to the value and the index, and then determine the compensation coefficient based on the second correspondence.

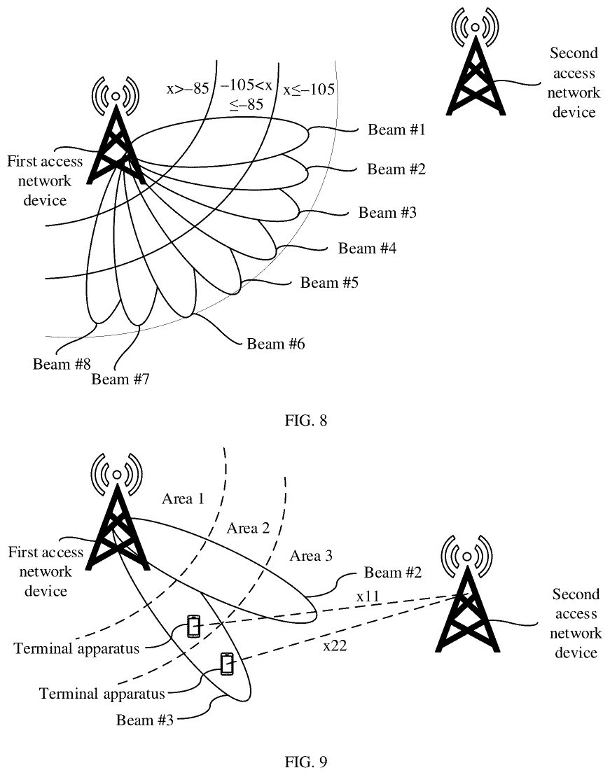

For example, as shown in FIG. 8 and Table 3, there are a plurality of second correspondences, such as, different value ranges of the receive power of the first signal and different indexes corresponding to the first signal correspond to different values of the compensation coefficient. After determining the value of the receive power of the first signal and the index corresponding to the first signal, the terminal apparatus may determine, from the plurality of second correspondences, a second correspondence corresponding to the value and the index, and then determine the corresponding compensation coefficient based on the second correspondence. It may be understood that the second correspondence shown in Table 3 is an example, and a plurality of different second correspondences may be alternatively set based on a situation. This is not limited.

TABLE 3

| Receive power x of | Index corresponding | Compensation |
|---|---|---|
| the first signal (dBm) | to the first signal | coefficient |
| x > −85 | 1 | 0.9 |
| | . | . |
| | . | . |
| | . | . |
| | 8 | 0.95 |
| −105 < x ≤ −85 | 1 | 0.84 |
| | . | . |
| | . | . |
| | . | . |
| | 8 | 0.89 |
| x ≤ −105 | 1 | 0.8 |
| | . | . |
| | . | . |
| | . | . |
| | 8 | 0.85 |

For example, if the information receive power of the first signal is-90 dBm, and the index of the first signal is 1, based on the correspondence shown in Table 2, it may be determined that the compensation coefficient corresponding to the index is 0.84.

It may be understood that the receive power of the first signal may reflect a distance between the terminal apparatus and the first access network device, and the index corresponding to the first signal may reflect an approximate orientation of the terminal apparatus. Therefore, an approximate location of the terminal apparatus may be determined by using the receive power of the first signal and the index corresponding to the first signal, so that the distance between the terminal apparatus and the second access network device can be determined. For the receive power of the first signal, refer to related descriptions of the foregoing “case 1”. For the index corresponding to the first signal, refer to related descriptions of the foregoing “manner 1”. Details are not described herein again.

For example, as shown in FIG. 9, cells of the first access network device may be classified by using the signal receive power and beam coverage of different beams. In FIG. 9, an area 1 to an area 3 are determined based on different ranges of the signal receive power. The area 1 is an area range in which the signal receive power is greater than-85 dBm, the area 2 is an area range in which the signal receive power is between −85 dBm and −105 dBm, and the area 3 is an area range in which the signal receive power is less than-105 dBm. If the terminal apparatus is located in the area 2 and is located in beam coverage corresponding to a beam #3, the distance between the terminal apparatus and the second access network device is x11; or if the terminal apparatus is located in the area 3 and is located in the beam coverage corresponding to the beam #3, the distance between the terminal apparatus and the second access network device is x22.

Because the compensation coefficient is positively correlated with the distance between the terminal apparatus and the second access network device, the compensation coefficient may be determined by determining the value of the compensation coefficient by using the second correspondence, the receive power of the first signal, and the index corresponding to the first signal.

In a possible embodiment, that the terminal apparatus obtains the compensation coefficient (S401) may include: receiving an SSS of the first access network device; and determining the compensation coefficient based on a signal receive power of the SSS and an index corresponding to the SSS. For an implementation of determining the compensation coefficient based on the signal receive power of the SSS and the index corresponding to the SSS, refer to related descriptions of the foregoing “manner 2”. Details are not described herein again.

For example, in the foregoing “scenario 2”, the second access network device is in a sleep state, and a cell of the first access network device and a cell of the second access network device are neighboring cells, or the first access network device is a macro base station and the second access network device is a micro base station of the macro base station. The terminal apparatus may send a UL WUS to wake up the second access network device. Before sending the UL WUS, the terminal apparatus may receive the SSS of the first access network device; and determine the compensation coefficient based on the signal receive power of the SSS and the index corresponding to the SSS, to determine a transmit power of the UL WUS based on the compensation coefficient.

For another example, in the foregoing “scenario 3”, the first access network device is a macro base station, the second access network device is a micro base station of the macro base station, and a downlink of the second access network is disabled. The terminal apparatus may send an uplink preamble signal to access the second access network device. Before sending the uplink preamble signal, the terminal apparatus may receive the SSS of the first access network device; and determine the compensation coefficient based on the signal receive power of the SSS and the index corresponding to the SSS, to determine a transmit power of the uplink preamble signal based on the compensation coefficient.

It may be understood that the foregoing content describes how to determine the compensation coefficient based on the information about the first signal. In different scenarios, the second correspondence may be carried in different messages. For example, for the foregoing “scenario 1”, the first access network device may periodically send a synchronization signal, and the synchronization signal includes a PSS and/or an SSS. Therefore, the second correspondence may be carried in the synchronization signal. For example, a plurality of different second correspondences may be preset, and each second correspondence corresponds to one quantity of bits. A currently used second correspondence is determined by using different quantities of bits carried in the synchronization signal. For another example, for the foregoing “scenario 2” and “scenario 3”, when the second access network device is in a sleep state, or the second access network device is a micro base station and a downlink is disabled, the terminal apparatus may receive an SSB, system information, and an RRC message from the first access network device. In this case, the second correspondence may be carried in the SSB, the system information, or the RRC message.

In addition, when the first access network device and the second access network device are a same device, that the terminal apparatus obtains the compensation coefficient (S401) may include: the terminal apparatus receives an SSS sent by the first access network device; and the terminal apparatus determines the compensation coefficient based on a signal receive power of the SSS and the second correspondence. When the first access network device and the second access network device are different devices, that the terminal apparatus obtains the compensation coefficient (S401) may include: the terminal apparatus receives an SSS sent by the first access network device; and determines the compensation coefficient based on an index corresponding to the SSS and the second correspondence; or determines the compensation coefficient based on a signal receive power of the SSS, an index corresponding to the SSS, and the second correspondence.

It may be further understood that the compensation coefficient may alternatively be determined based on other information. For example, signal coverage of the first access network device may be divided into a plurality of areas based on longitude and latitude, and each area corresponds to a unique area mark. The terminal apparatus may obtain, by obtaining an area mark of an area to which a location of the terminal apparatus belongs, a compensation coefficient corresponding to the area mark. A correspondence between different area marks and values of the compensation coefficient may be preset or protocol-predefined. This is not limited herein. For another example, the compensation coefficient may alternatively be determined based on reference signal received quality (RSRQ), a signal to interference plus noise ratio (SINR), or a signal-to-noise ratio (SNR). In other words, the compensation coefficient may be determined by using signal quality represented by the RSRQ, the SINR, or the SNR. An implementation of this manner is similar to a principle of determining the compensation coefficient based on the receive power of the first signal in the foregoing “case 1.1”. For details, refer to related descriptions of the foregoing “case 1.1” and “case 1.2”. Details are not described herein again.

S402: the terminal apparatus sends the second signal to the second access network device based on the compensation coefficient.

The second signal may have different functions in different scenarios. For example, in the foregoing “scenario 1”, the second signal may be used to request the second access network device to send the system information; or in the foregoing “scenario 2”, the second signal may be used to wake up the second access network device in the sleep state; or in the foregoing “scenario 3”, the second signal may be used for random access. This is not limited.

The transmit power of the second signal is determined based on the compensation coefficient. In other words, before sending the second signal to the second access network device, the terminal apparatus may determine the transmit power of the second signal based on the compensation coefficient.

For example, the terminal apparatus may determine the transmit power of the second signal based on a maximum transmit power of the terminal apparatus and the compensation coefficient. For example, in this case, the transmit power of the second signal is determined based on the maximum transmit power of the terminal apparatus and the compensation coefficient. Alternatively, the terminal apparatus may determine the compensation coefficient based on a signal receive power expected by the second access network device, a path loss between the terminal apparatus and the first access network device, and the compensation coefficient. For example, in this case, the transmit power of the second signal is determined based on the signal receive power expected by the second access network device, the path loss between the terminal apparatus and the first access network device, and the compensation coefficient. The following provides descriptions in different cases.

Case 2.1: the terminal apparatus determines the transmit power of the second signal based on the maximum transmit power of the terminal apparatus and the compensation coefficient.

The maximum transmit power is an uplink maximum transmit power corresponding to a power level of the terminal apparatus, and the power level is a maximum output power of any transmission bandwidth within a channel bandwidth of an NR carrier. For a principle of the maximum transmit power, refer to a principle in the conventional technology. Details are not described herein again. The terminal apparatus may obtain the maximum transmit power by using an RRC message configured with a maximum transmit power on each carrier, or use a protocol-predefined maximum transmit power. For example, in the foregoing “scenario 1”, because the terminal apparatus has no configuration information, the terminal apparatus may use the protocol-predefined maximum transmit power. For another example, in the foregoing “scenario 2”, the terminal apparatus may obtain the maximum transmit power by using the RRC message. In other words, the terminal apparatus may flexibly select, based on a situation, different manners of obtaining the maximum transmit power.

After obtaining the maximum transmit power, the terminal apparatus may determine an uplink expected transmit power based on the maximum transmit power and the compensation coefficient, and the uplink expected transmit power is a product of the maximum transmit power and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},α₁·P_{CMAX}} (3)

P is the transmit power of the second signal, P_{CMAX} is the maximum transmit power of the terminal apparatus, α₁ is the compensation coefficient, and min{P_{CMAX},α₁·P_{CMAX}} represents selecting a smaller value from P_{CMAX} and α₁·P_{CMAX}.

Optionally, the terminal apparatus may determine the transmit power of the second signal based on the maximum transmit power of the terminal, the compensation coefficient, and at least one of the following: power boost step or operation or a first power offset (which is described below). For example, the transmit power of the second signal is determined based on the maximum transmit power of the terminal apparatus, the compensation coefficient, and at least one of the following: the power boost step or operation or the first power offset. The following separately describes manners of determining the transmit power of the second signal.

In a first possible embodiment, the terminal apparatus determines the transmit power of the second signal based on the maximum transmit power of the terminal, the compensation coefficient, and the power boost step or operation. For example, the transmit power of the second signal is determined based on the maximum transmit power of the terminal apparatus, the compensation coefficient, and the power boost step or operation.

The power boost step or operation is a power increased during retransmission of the second signal, and may represent a difference between powers of two adjacent signals. Therefore, the power boost step or operation may also be referred to as a retransmission power boost step or operation. For example, if the power boost step or operation is 3 dBm, the second signal and a signal #1 are two adjacent sent signals, the signal #1 is sent before the second signal, and a transmit power of the signal #1 is v, the transmit power of the second signal is v+3. For another example, if the power boost step or operation is 3 dBm, a transmit power of an initially-transmitted signal #11 is x, and the second signal is a signal that is retransmitted for the second time, the transmit power of the second signal is x+6.

The power boost step or operation may be preset or protocol-predefined, or may be sent by the first access network device. For example, value information of the power boost step or operation is carried in a synchronization signal, system information, or an RRC message, and the first access network device broadcasts the synchronization signal, the system information, or the RRC message. It may be understood that a manner of obtaining a value of the power boost step or operation may be flexibly set based on a situation.

For example, when the second signal is a retransmitted signal, the terminal apparatus may determine an expected uplink transmit power based on the maximum transmit power of the terminal apparatus, the compensation coefficient, and the power boost step or operation, and the expected uplink transmit power is a sum of the power boost step or operation and a product of the maximum transmit power and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal. In this way, reliability of the second signal may be improved by increasing the power boost step or operation, for example, a possibility that the second access network device successfully receives the second signal can be improved.

In this case, the transmit power of the second signal may be expressed as:

P=min{P_{CMAX},α₁·P_{CMAX}+Δ₁} (4)

Δ1 is the power boost step or operation, and min{P_{CMAX},α₁·P_{CMAX}+Δ₁} represents selecting a smaller value from P_{CMAX} and α₁·P_{CMAX}+Δ₁.

In a second possible embodiment, the terminal apparatus determines the transmit power of the second signal based on the maximum transmit power of the terminal, the compensation coefficient, and the first power offset. For example, the transmit power of the second signal is determined based on the maximum transmit power of the terminal apparatus, the compensation coefficient, and the first power offset.

The first power offset is determined based on service information of the terminal apparatus, for example, the terminal apparatus may determine the first power offset based on the service information of the terminal apparatus. The service information may indicate urgency of a service to be sent by the terminal apparatus, for example, a latency requirement of the service. The service information may be quality of service (QoS) of the service or other information that can indicate the urgency of the service. This is not limited. It may be understood that if the service is more urgent, the terminal apparatus expects the second access network device to receive the second signal more quickly. Therefore, in this case, the first power offset is larger.

For example, the terminal apparatus may determine the first power offset based on the service information of the terminal apparatus and the first correspondence, for example, the first power offset is determined based on the service information of the terminal apparatus and the first correspondence. The first correspondence is a correspondence between the service information of the terminal apparatus and a value of the first power offset. The first correspondence may be preset or protocol-predefined, or may be from the first access network device. In other words, the first access network device may obtain the first correspondence, and send the first correspondence. Correspondingly, the terminal apparatus receives the first correspondence from the first access network device. In this case, the first correspondence may be carried in at least one of the following messages: system information, a synchronization signal, or an RRC message.

It may be understood that a plurality of different first correspondences may be preset or protocol-predefined; or the first access network device may send a plurality of different first correspondences. The plurality of different first correspondences are a plurality of correspondences between a plurality of types of different service information and a plurality of values of the first power offset, and the plurality of types of different service information are in one-to-one correspondence with the plurality of values. In this case, the terminal apparatus may select, from the plurality of first correspondences based on the service information of the terminal apparatus, a first correspondence corresponding to the service information of the terminal apparatus, and then determine the first power offset based on the first correspondence.

For example, as shown in Table 4, there are a plurality of first correspondences in Table 4, and a 5QI (5G QoS Identifier) in Table 4 indicates a QoS level. It may be understood that 82 to 85 correspond to a low-latency service, for example, the service is urgent, and therefore the first power offset may be set to a large value, for example, 3 dBm. 80 corresponds to a medium-latency service, for example, urgency of the service is general, and therefore the first power offset may be set to a medium value, for example, 2 dBm. 1 to 4 and 71 to 76 correspond to a latency-insensitive service, for example, the service is not urgent, and therefore the first power offset may be set to a small value, for example, 1 dBm. 40 corresponds to a service that has no latency requirement, for example, the service is not urgent, and therefore the first power offset may be set to 0. It may be understood that the first correspondence shown in Table 4 is an example, and different first correspondences may be further set based on a situation. This is not limited.

TABLE 4

| | First power |
|---|---|
| 5QI | offset (dBm) |
| 82 to 85 (or another value corresponding to an ultra- | 3 |
| reliable low-latency communication (ultra-reliable low- | |
| latency communication, URLLC) service) | |
| 80 (or another value corresponding to a medium-latency | 2 |
| enhanced mobile broadband (enhanced mobile broadband, | |
| eMBB) service) | |
| 1 to 4 and 71 to 76 (or another value corresponding to an | 1 |
| eMBB latency-insensitive service) | |
| 40 (or another value corresponding to a reduced capability | 0 |
| (reduced capability, RedCap) service) | |

It may be understood that in 4G, a QoS class identifier (QCI) represents a QoS level; in 5G, a 5QI represents a QoS level; and in a future communication system, another named parameter may represent a QoS level. This is not limited.

After obtaining the first power offset, the terminal apparatus may determine an expected uplink transmit power based on the maximum transmit power of the terminal apparatus, the compensation coefficient, and the first power offset, and the expected uplink transmit power is a sum of the first power offset and a product of the maximum transmit power and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal. In this way, the terminal apparatus may adjust the transmit power of the second signal based on the urgency of the service to be sent. For example, if the service is more urgent, the transmit power of the second signal is larger, to improve reliability of the second signal.

In this case, the transmit power of the second signal may be expressed as:

P=min{P_{CMAX},α₁·P_{CMAX}+Δ₂} (5)

Δ₂ is the first power offset, and min{P_{CMAX},α₁·P_{CMAX}+Δ₂} represents selecting a smaller value from P_{CMAX} and α₁·P_{CMAX}+Δ₂.

In a third possible embodiment, the terminal apparatus determines the transmit power of the second signal based on the maximum transmit power of the terminal, the compensation coefficient, the power boost step or operation, and the first power offset. For example, the transmit power of the second signal is determined based on the maximum transmit power of the terminal apparatus, the compensation coefficient, the power boost step or operation, and the first power offset.

For the power boost step or operation and the first power offset, refer to the foregoing related content. Details are not described herein again.

For example, when the second signal is a retransmitted signal, and the terminal apparatus has a service to be sent, the terminal apparatus may determine an expected uplink transmit power based on the maximum transmit power of the terminal apparatus, the compensation coefficient, the power boost step or operation, and the first power offset, and the expected uplink transmit power is a sum of the power boost step or operation, the first power offset, and a product of the maximum transmit power and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal. In this way, the transmit power of the second signal may be adjusted based on a situation by using the power boost step or operation and the first power offset, to improve reliability of the second signal.

In this case, the transmit power of the second signal may be expressed as:

P=min{P_{CMAX},α₁·P_{CMAX}+Δ₁+Δ₂} (6)

Δ₁ is the power boost step or operation, Δ₂ is the first power offset, and min{P_{CMAX},α₁·P_{CMAX}+Δ₁+Δ₂} represents selecting a smaller value from P_{CMAX} and α₁·P_{CMAX}+Δ₁+Δ₂.

Case 2.2: the terminal apparatus may determine the compensation coefficient based on the signal receive power expected by the second access network device, the path loss (denoted as the path loss #1) between the terminal apparatus and the first access network device, and the compensation coefficient.

The signal receive power expected by the second access network device is higher-layer configured, and may be sent by the first access network device to the terminal apparatus. For example, the signal receive power may be carried in a synchronization signal, system information, and an RRC message. It may be understood that a plurality of different signal receive powers expected by the second access network device may be preset, and each signal receive power corresponds to one quantity of bits, so that the signal receive powers expected by the second access network device are determined by using different quantities of bits carried in the synchronization signal.

The path loss #1 may be determined based on a signal transmit power (denoted as a signal transmit power #1) of the first access network device and a signal receive power (denoted as a signal receive power #1) of a signal received by the terminal apparatus from the first access network device. The signal transmit power #1 may be carried in a signal periodically sent by the first access network device, for example, carried in system information (for example, a SIB 1), so that the terminal apparatus can obtain the signal transmit power #1 by receiving the signal. The signal receive power #1 may be obtained by measuring an SSS sent by the first access network device. After obtaining the signal transmit power #1 and the signal receive power #1, the terminal apparatus may subtract the signal receive power #1 from the signal transmit power #1, to obtain the path loss #1.

The terminal apparatus may multiply the path loss #1 by the compensation coefficient, to obtain a path loss (denoted as a path loss #2) between the terminal apparatus and the second access network device. Then, the terminal apparatus may add the signal receive power expected by the second access network device to the path loss #2, so that an expected uplink transmit power can be obtained. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},Pₑ+α₂·PL} (7)

P is the transmit power of the second signal, P_{CMAX} is the maximum transmit power of the terminal apparatus, Pₑ is the signal receive power expected by the second access network device, α₂ is the compensation coefficient, PL is the path loss #1, and min{P_{CMAX},Pₑ+α₂·PL} represents selecting a smaller value from P_{CMAX} and Pₑ+α₂·PL.

Optionally, the terminal apparatus may determine the transmit power of the second signal based on the signal receive power expected by the second access network device, the path loss #1, the compensation coefficient, and at least one of the following: a power boost step or operation, a first power offset, or a first adjustment amount (which is described below). For example, the transmit power of the second signal is determined based on the signal receive power expected by the second access network device, the path loss #1, the compensation coefficient, and at least one of the following: the power boost step or operation, the first power offset, or the first adjustment amount. For the power boost step or operation and the first power offset, refer to related descriptions of the foregoing “case 2.1”. Details are not described herein again. The following separately describes manners of determining the transmit power of the second signal.

In a first possible embodiment, the terminal apparatus determines the transmit power of the second signal based on the signal receive power expected by the second access network device, the path loss #1, the compensation coefficient, and the power boost step or operation. For example, the transmit power of the second signal is determined based on the signal receive power expected by the second access network device, the path loss #1, the compensation coefficient, and the power boost step or operation.

For example, when the second signal is a retransmitted signal, the terminal apparatus may determine an expected uplink transmit power based on the signal receive power expected by the second access network device, the path loss #1, the compensation coefficient, and the power boost step or operation, and the expected uplink transmit power is a sum of the signal receive power expected by the second access network device, the power boost step or operation, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal. In this way, reliability of the second signal may be improved by increasing the power boost step or operation, for example, a possibility that the second access network device successfully receives the second signal can be improved.

In this case, the transmit power of the second signal may be expressed as:

P=min{P_{CMAX},Pₑ+α₂·PL+Δ₁} (8)

Δ₁ is the power boost step or operation, and min{P_{CMAX},Pₑ+α₂·PL+Δ₁} represents selecting a smaller value from P_{CMAX} and Pₑ+α₂·PL+Δ₁.

In a second possible embodiment, the terminal apparatus determines the transmit power of the second signal based on the signal receive power expected by the second access network device, the path loss #1, the compensation coefficient, and the first power offset. For example, the transmit power of the second signal is determined based on the signal receive power expected by the second access network device, the path loss #1, the compensation coefficient, and the first power offset.

For example, when the terminal apparatus has a service to be sent, the terminal apparatus may determine the first power offset based on service information of the service, for example, QoS; and then determine an expected uplink transmit power based on the signal receive power expected by the second access network device, the path loss #1, the compensation coefficient, and the first power offset, and the expected uplink transmit power is a sum of the signal receive power expected by the second access network device, the first power offset, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal. In this way, the terminal apparatus may adjust the transmit power of the second signal based on urgency of the service to be sent. For example, if the service is more urgent, the transmit power of the second signal is larger, to improve reliability of the second signal.

In this case, the transmit power of the second signal may be expressed as:

P=min{P_{CMAX},Pₑ+α₂·PL+Δ₂} (9)

Δ₂ is the first power offset, and min{P_{CMAX},Pₑ+α₂·PL+Δ₂} represents selecting a smaller value from P_{CMAX} and Pₑ+α₂·PL+Δ₂.

In a third possible embodiment, the terminal apparatus determines the transmit power of the second signal based on the signal receive power expected by the second access network device, the path loss #1, the compensation coefficient, and the first adjustment amount. For example, the transmit power of the second signal is determined based on the signal receive power expected by the second access network device, the path loss #1, the compensation coefficient, and the first adjustment amount.

The first adjustment amount is a power adjustment amount related to frequency domain resource allocation and link adaptation that correspond to the second signal, and is related to a quantity of RBs used for transmitting the second signal. It may be understood that the quantity of RBs used for transmitting the second signal may be fixed, or may dynamically change, for example, RB data used for each transmission may be different. When the quantity of RBs is a fixed value, the value of the quantity of RBs may be preset or protocol-predefined, or the value of the quantity of RBs may be sent by the first access network device. When the quantity of RBs dynamically changes, the value of the quantity of RBs may be sent by the first access network device.

For example, the terminal apparatus may determine an expected uplink transmit power based on the signal receive power expected by the second access network device, the path loss #1, the compensation coefficient, and the first adjustment amount, and the expected uplink transmit power is a sum of the signal receive power expected by the second access network device, the first adjustment amount, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},Pₑ+α₂·PL+10 log₁₀(2^{μ}·M_{RB})} (10)

10 log₁₀(2^{μ}·M_{RB}) is the first adjustment amount, μ is a subcarrier spacing used for transmitting the second signal, M_{RB} is a quantity of RBs occupied for transmitting the second signal, and min{P_{CMAX},Pₑ+α₂·PL+43} represents selecting a smaller value from P_{CMAX} and Pₑ+α₂·PL+10 log₁₀(2^{μ}·M_{RB}).

In a fourth possible embodiment, the terminal apparatus determines the transmit power of the second signal based on the signal receive power expected by the second access network device, the path loss #1, the compensation coefficient, the power boost step or operation, and the first power offset. For example, the transmit power of the second signal is determined based on the signal receive power expected by the second access network device, the path loss #1, the compensation coefficient, the power boost step or operation, and the first power offset.

For example, when the second signal is a retransmitted signal, and the terminal apparatus has a service to be sent, the terminal apparatus may determine an expected uplink transmit power based on the signal receive power expected by the second access network device, the path loss #1, the compensation coefficient, the power boost step or operation, and the first power offset, and the expected uplink transmit power is a sum of the signal receive power expected by the second access network device, the power boost step or operation, the first power offset, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},Pₑ+α₂·PL+Δ₁+Δ₂} (11)

Δ₁ is the power boost step or operation, Δ₂ is the first power offset, and min{P_{CMAX},Pₑ+α₂·PL+Δ₁+Δ₂} represents selecting a smaller value from P_{CMAX} and Pₑ+α₂·PL+Δ₁+Δ₂.

In a fifth possible embodiment, the terminal apparatus determines the transmit power of the second signal based on the signal receive power expected by the second access network device, the path loss #1, the compensation coefficient, the power boost step or operation, and the first adjustment amount. For example, the transmit power of the second signal is determined based on the signal receive power expected by the second access network device, the path loss #1, the compensation coefficient, the power boost step or operation, and the first adjustment amount. For example, when the second signal is a retransmitted signal, the terminal apparatus may determine an expected uplink transmit power based on the signal receive power expected by the second access network device, the path loss #1, the compensation coefficient, the power boost step or operation, and the first adjustment amount, and the expected uplink transmit power is a sum of the signal receive power expected by the second access network device, the power boost step or operation, the first adjustment amount, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},Pₑ+α₂·PL+Δ₁+10 log₁₀(2^{μ}·M_{RB})} (12)

Δ₁ is the power boost step or operation, 10 log₁₀(2^{μ}·M_{RB}) is the first adjustment amount, μ is a subcarrier spacing used for transmitting the second signal, M_{RB} is a quantity of RBs occupied for transmitting the second signal, and min{P_{CMAX},Pₑ+α₂·PL+Δ₁+10 log₁₀(2^{μ}·M_{RB})} represents selecting a smaller value from P_{CMAX} and Pₑ+α₂·PL+Δ₁+10 log₁₀(2^{μ}·M_{RB}).

In a sixth possible embodiment, the terminal apparatus determines the transmit power of the second signal based on the signal receive power expected by the second access network device, the path loss #1, the compensation coefficient, the first power offset, and the first adjustment amount. For example, the transmit power of the second signal is determined based on the signal receive power expected by the second access network device, the path loss #1, the compensation coefficient, the first power offset, and the first adjustment amount.

For example, when the terminal apparatus has a service to be sent, the terminal apparatus may determine an expected uplink transmit power based on the signal receive power expected by the second access network device, the path loss #1, the compensation coefficient, the first power offset, and the first adjustment amount, and the expected uplink transmit power is a sum of the signal receive power expected by the second access network device, the first power offset, the first adjustment amount, and a product of the path loss #1 and the compensation coefficient. After determining the expected uplink transmit power, the terminal apparatus may compare the expected uplink transmit power with the maximum transmit power of the terminal apparatus, and use a smaller value of the expected uplink transmit power and the maximum transmit power of the terminal apparatus as the transmit power of the second signal.

In this case, the transmit power of the second signal may be expressed as:

P=min{P_{CMAX},Pₑ+α₂·PL+Δ₂+10 log₁₀(2^{μ}·M_{RB})} (13)

Δ₂ is the first power offset, 10 log₁₀(2^{μ}·M_{RB}) is the first adjustment amount, μ is a subcarrier spacing used for transmitting the second signal, M_{RB} is a quantity of RBs occupied for transmitting the second signal, and min{P_{CMAX},Pₑ+α₂·PL+Δ₂+10 log₁₀(2^{μ}·M_{RB})} represents selecting a smaller value from P_{CMAX} and Pₑ+α₂·PL+Δ₂+10 log₁₀(2^{μ}·M_{RB}).

In a seventh possible embodiment, the terminal apparatus may determine the transmit power of the second signal based on the signal receive power expected by the second access network device, the path loss #1, the compensation coefficient, the power boost step or operation, the first power offset, and the first adjustment amount. For example, the transmit power of the second signal is determined based on the signal receive power expected by the second access network device, the path loss #1, the compensation coefficient, the power boost step or operation, the first power offset, and the first adjustment amount.

For example, when the second signal is a retransmitted signal, and the terminal apparatus has a service to be sent, the terminal apparatus may determine an expected uplink transmit power based on the signal receive power expected by the second access network device, the path loss #1, the compensation coefficient, the power boost step or operation, the first power offset, and the first adjustment amount, and the expected uplink transmit power is a sum of the signal receive power expected by the second access network device, the power boost step or operation, the first power offset, the first adjustment amount, and a product of the path loss #1 and the compensation coefficient.

In this case, the transmit power of the second signal may be expressed as:

P=min{P_{CMAX},Pₑ+α₂·PL+Δ₁+Δ₂+10 log₁₀(2^{μ}·M_{RB})} (14)

Δ₁ is the power boost step or operation, Δ₂ is the first power offset, 10 log₁₀(2^{μ}·M_{RB}) is the first adjustment amount, μ is a subcarrier spacing used for transmitting the second signal, M_{RB} is a quantity of RBs occupied for transmitting the second signal, and min{P_{CMAX},Pₑ+α₂·PL+Δ₁+Δ₂+10 log₁₀(2^{μ}·M_{RB})} represents selecting a smaller value from P_{CMAX} and Pₑ+α₂·PL+Δ₁+Δ₂+10 log₁₀(2^{μ}·M_{RB}).

It may be understood that the foregoing content describes a plurality of manners of determining the transmit power of the second signal. It may be understood that in any manner, the transmit power of the second signal is less than or equal to the maximum transmit power of the terminal apparatus. In other words, the transmit power of the second signal is the maximum transmit power of the terminal apparatus. In this way, it may be ensured that the terminal apparatus successfully sends the second signal.

It may be further understood that the message (for example, the system information, the synchronization signal, or the RRC message) sent by the first access network device may carry at least two of the following information: the first correspondence, the second correspondence, the signal receive power expected by the second access network device, and the signal transmit power of the first access network device. In other words, the terminal apparatus may obtain a plurality of pieces of information from one message from the first access network device. In addition, the terminal apparatus may obtain a plurality of pieces of information from a plurality of messages from the first access network device. This is not limited.

Therefore, the compensation coefficient may be determined based on the information about the first signal (for example, the receive power of the first signal and/or the index corresponding to the first signal). Because the information about the first signal may reflect a location relationship between the terminal apparatus and the second access network device, the compensation coefficient may represent the location relationship between the terminal apparatus and the second access network device. After obtaining the compensation coefficient, the terminal apparatus may determine the transmit power of the second signal based on the compensation coefficient and the maximum transmit power of the terminal apparatus, or may determine the transmit power of the second signal based on the transmit power expected by the second access network device, the compensation coefficient, and the path loss between the terminal apparatus and the first access network device. In this way, when the terminal apparatus cannot obtain the path loss between the terminal apparatus and the second access network device, the terminal apparatus can determine an appropriate transmit power of the second signal based on the compensation coefficient.

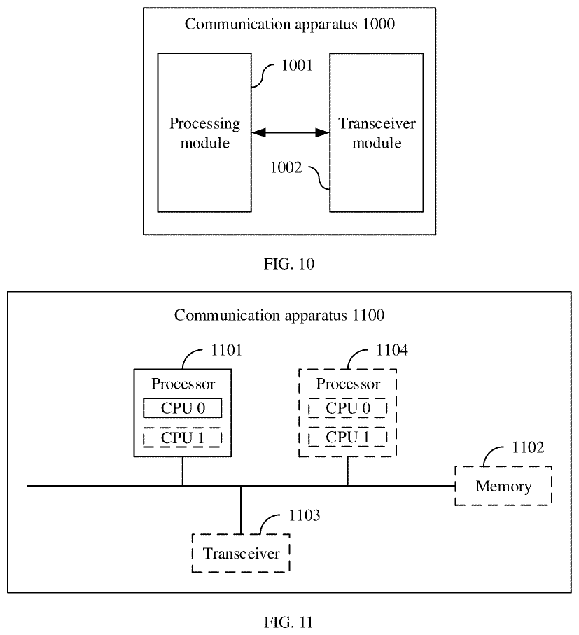

The foregoing describes in detail, with reference to FIG. 4 to FIG. 9, the communication method provided in embodiments. The following describes in detail, with reference to FIG. 10 and FIG. 11, a communication apparatus configured to perform the communication method provided in embodiments.

FIG. 10 is a diagram 1 of a structure of a communication apparatus according to an embodiment. For example, as shown in FIG. 10, the communication apparatus 1000 includes a processing module 1001 and a transceiver module 1002. For ease of description, FIG. 10 shows only main parts of the communication apparatus.

In some embodiments, the communication apparatus 1000 may be applied to the communication system shown in FIG. 2, and perform a function of the terminal apparatus in the communication method shown in FIG. 4.

The processing module 1001 is configured to obtain a compensation coefficient, where the compensation coefficient is determined based on information about a first signal sent by a first access network device, and the information about the first signal includes at least one of the following: a receive power of the first signal or an index corresponding to the first signal; and the transceiver module 1002 is configured to send a second signal to a second access network device based on the compensation coefficient, where a transmit power of the second signal is determined based on the compensation coefficient.

In a possible embodiment, the transmit power of the second signal is determined based on the maximum transmit power of the terminal apparatus and the compensation coefficient.

Optionally, the transmit power of the second signal is determined based on the maximum transmit power of the terminal apparatus, the compensation coefficient, and a power boost step or operation, or the transmit power of the second signal is determined based on the maximum transmit power of the terminal apparatus, the compensation coefficient, and a first power offset, or the transmit power of the second signal is determined based on the maximum transmit power of the terminal apparatus, the compensation coefficient, a power boost step or operation, and a first power offset; and the power boost step or operation is a power increased during retransmission of the second signal, and the first power offset is determined based on service information of the terminal apparatus.

Further, the transmit power of the second signal is expressed as P=min{P_{CMAX}, @1. P_{CMAX}+Δ₁+Δ₂}, where P is the transmit power of the second signal, P_{CMAX} is the maximum transmit power of the terminal apparatus, «1 is the compensation coefficient, Δ₁ is the power boost step or operation, Δ₂ is the first power offset, and min{P_{CMAX},α₁·P_{CMAX}+Δ₁+Δ₂} represents selecting a smaller value from P_{CMAX} and α₁·P_{CMAX}+Δ₁+Δ₂.

In a possible embodiment, the transmit power of the second signal is determined based on a signal receive power expected by the second access network device, a path loss between a terminal apparatus and the first access network device, and the compensation coefficient.

Optionally, the transmit power of the second signal is determined based on the signal receive power expected by the second access network device, the path loss, the compensation coefficient, and a power boost step or operation, or the transmit power of the second signal is determined based on the signal receive power expected by the second access network device, the path loss, the compensation coefficient, and a first power offset, or the transmit power of the second signal is determined based on the signal receive power expected by the second access network device, the path loss, the compensation coefficient, and a first adjustment amount, or the transmit power of the second signal is determined based on the signal receive power expected by the second access network device, the path loss, the compensation coefficient, a power boost step or operation, and a first power offset, or the transmit power of the second signal is determined based on the signal receive power expected by the second access network device, the path loss, the compensation coefficient, a power boost step or operation, and a first adjustment amount, or the transmit power of the second signal is determined based on the signal receive power expected by the second access network device, the path loss, the compensation coefficient, a first power offset, and a first adjustment amount, or the transmit power of the second signal is determined based on the signal receive power expected by the second access network device, the path loss, the compensation coefficient, a power boost step or operation, a first power offset, and a first adjustment amount; and the power boost step or operation is a power increased during retransmission of the second signal, the first power offset is determined based on service information of the terminal apparatus, and the first adjustment amount is a power adjustment amount related to frequency domain resource allocation and link adaptation that correspond to the second signal.

Further, the transmit power of the second signal is expressed as P=min{P_{CMAX},Pₑ+α₂·PL+Δ₁}, where P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step or operation, and min{P_{CMAX},Pₑ+α₂·PL+Δ₁} represents that a smaller value is selected from P_{CMAX} and Pₑ+α₂·PL+Δ₁.

Further, the transmit power of the second signal is expressed as P=min{P_{CMAX},Pₑ+α₂·PL+Δ₁+Δ₂+10 log₁₀(2^{μ}·M_{RB})}, where P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step or operation, Δ₂ is the first power offset, 10 log₁₀(2^{μ}·M_{RB}) is the first adjustment amount, μ corresponds to a subcarrier spacing used for transmitting the second signal, M_{RB} is a quantity of RBs occupied for transmitting the second signal, and min{P_{CMAX},Pₑ+α₂·PL+Δ₁+Δ₂+10 log₁₀(2^{μ}·M_{RB})} represents that a smaller value is selected from P_{CMAX} and Pₑ+α₂·PL+Δ₁+Δ₂+10 log₁₀(2^{μ}·M_{RB}).

Further, the first power offset is determined based on a first correspondence between the service information of the terminal apparatus and a value of the first power offset.

Further, the first correspondence is from the first access network device, and the first correspondence is carried in at least one of the following messages: system information, a synchronization signal, or an RRC message; or the first correspondence is protocol-predefined.

In a possible embodiment, the processing module 1001 is configured to determine the compensation coefficient based on a second correspondence and the information about the first signal, where the second correspondence is a correspondence between a value range of the receive power of the first signal and a value of the compensation coefficient, or the second correspondence is a correspondence between the index corresponding to the first signal and a value of the compensation coefficient, or the second correspondence is a correspondence between a value range of the receive power of the first signal, the index corresponding to the first signal, and a value of the compensation coefficient.

Optionally, the second correspondence is from the first access network device, and the second correspondence is carried in at least one of the following messages: the system information, the synchronization signal, or the RRC message; or the second correspondence is protocol-predefined.

In a possible embodiment, the first access network device and the second access network device are a same device, and the transceiver module 1002 is configured to receive a secondary synchronization signal SSS sent by the first access network device; and the processing module 1001 is configured to determine the compensation coefficient based on a signal receive power of the SSS.

In a possible embodiment, the first access network device and the second access network device are a same device, and the value of the compensation coefficient is inversely correlated with a value of the receive power of the first signal.

In a possible embodiment, a cell of the first access network device and a cell of the second access network device are neighboring cells of each other, or the first access network device is a macro base station and the second access network device is a micro base station of the macro base station; and the transceiver module 1002 is configured to receive an SSS of the first access network device; and the processing module 1001 is configured to determine the compensation coefficient based on a signal receive power of the SSS and an index corresponding to the SSS, or an index corresponding to the SSS.

In a possible embodiment, the transmit power of the second signal is less than or equal to the maximum transmit power of the terminal apparatus.

Optionally, the transceiver module 1002 may include a sending module (not shown in FIG. 10) and a receiving module (not shown in FIG. 10). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 10), and the storage module stores a program or instructions. When the processing module 1001 executes the program or the instructions, the communication apparatus 1000 is enabled to perform a function of the terminal apparatus in the method shown in FIG. 4 in the foregoing method.

It may be understood that the communication apparatus 1000 may be a terminal, for example, a remote UE or a remote device, or may be a chip (system) or another part or component that may be disposed in a terminal, or may be an apparatus including a terminal. This is not limited.

In addition, for effect of the communication apparatus 1000, refer to the effect of the communication method shown in FIG. 4. Details are not described herein again.

In some other embodiments, the communication apparatus 1000 may be applied to the communication system shown in FIG. 2, and perform a function of the first access network device in the method shown in FIG. 4.

The processing module 1001 is configured to obtain a second correspondence, where the second correspondence indicates a correspondence between a value range of a receive power of a first signal and a value of a compensation coefficient, or the second correspondence indicates a correspondence between an index corresponding to a first signal and a value of a compensation coefficient, or the second correspondence indicates a correspondence between a value range of a receive power of a first signal, an index corresponding to the first signal, and a value of a compensation coefficient; and the transceiver module 1002 is configured to send the second correspondence.

In a possible embodiment, the transceiver module 1002 is further configured to send a first correspondence, where the first correspondence indicates a correspondence between service information and a value of a first power offset.

Optionally, the transceiver module 1002 may include a sending module (not shown in FIG. 10) and a receiving module (not shown in FIG. 10). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 10), and the storage module stores a program or instructions. When the processing module 1001 executes the program or the instructions, the communication apparatus 1000 is enabled to perform a function of the first access network device in the method shown in FIG. 4 in the foregoing method.

It may be understood that the communication apparatus 1000 may be a network device, or may be a chip (system) or another part or component that may be disposed in a network device, or may be an apparatus including a network device. This is not limited.

In addition, for effect of the communication apparatus 1000, refer to the effect of the communication method shown in FIG. 4. Details are not described herein again.

FIG. 11 is a diagram 2 of a structure of a communication apparatus according to an embodiment. For example, the communication apparatus may be a terminal, or may be a chip (system) or another part or component that may be disposed in a terminal. As shown in FIG. 11, the communication apparatus 1100 may include a processor 1101. Optionally, the communication apparatus 1100 may further include a memory 1102 and/or a transceiver 1103. The processor 1101 is coupled to the memory 1102 and the transceiver 1103, for example, may be connected to the memory 1102 and the transceiver 1103 through a communication bus.

The following describes parts of the communication apparatus 1100 in detail with reference to FIG. 11.

The processor 1101 is a control center of the communication apparatus 1100, and may be one processor, or may be an umbrella term of a plurality of processing elements. For example, the processor 1101 is one or more central processing units (CPU), may be an application-specific integrated circuit (ASIC), or is configured as one or more integrated circuits implementing embodiments, for example, one or more microprocessors (DSP) or one or more field programmable gate arrays (FPGA).

Optionally, the processor 1101 may perform various functions of the communication apparatus 1100 by running or executing a software program stored in the memory 1102 and invoking data stored in the memory 1102, for example, perform the communication method shown in FIG. 4.

During an implementation, in an embodiment, the processor 1101 may include one or more CPUs, for example, a CPU 0 and a CPU 1 shown in FIG. 11.

During an implementation, in an embodiment, the communication apparatus 1100 may alternatively include a plurality of processors, for example, the processor 1101 and a processor 1104 shown in FIG. 11. Each of the processors may be a single-core processor (single-CPU), or may be a multi-core processor (multi-CPU). The processor herein may be one or more devices, circuits, and/or processing cores configured to process data (for example, computer program instructions).

The memory 1102 is configured to store a software program for executing the solutions in the embodiments, and the processor 1101 controls execution of the software program. For an implementation, refer to the foregoing method embodiments. Details are not described herein again.

Optionally, the memory 1102 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another compact disc storage, an optical disc storage (including a compressed optical disc, a laser disc, an optical disc, a digital versatile disc, a Blu-ray disc, or the like), a magnetic disk storage medium or another magnetic storage device, or any other medium that can be used to carry or store expected program code in a form of instructions or a data structure and that can be accessed by a computer. However, this is not limited thereto. The memory 1102 may be integrated with the processor 1101, or may exist independently, and is coupled to the processor 1101 through an interface circuit (not shown in FIG. 11) of the communication apparatus 1100. This is not limited.

The transceiver 1103 is configured to communicate with another communication apparatus. For example, the communication apparatus 1100 is a terminal, and the transceiver 1103 may be configured to communicate with a network apparatus or communicate with another terminal device. For another example, the communication apparatus 1100 is a network apparatus, and the transceiver 1103 may be configured to communicate with a terminal or communicate with another network apparatus.

Optionally, the transceiver 1103 may include a receiver and a transmitter (not separately shown in FIG. 11). The receiver is configured to implement a receiving function, and the transmitter is configured to implement a sending function.

Optionally, the transceiver 1103 may be integrated with the processor 1101, or may exist independently, and is coupled to the processor 1101 through an interface circuit (not shown in FIG. 11) of the communication apparatus 1100. This is not limited.

It may be understood that a structure of the communication apparatus 1100 shown in FIG. 11 does not constitute a limitation on the communication apparatus. A communication apparatus may include more or fewer parts than those shown in the figure, or combine some parts, or have different part arrangements.

In addition, for effect of the communication apparatus 1100, refer to the effect of the method in the foregoing method embodiments. Details are not described herein again.

It should be understood that the processor in embodiments may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be understood that the memory in embodiments may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (electrically EPROM, EEPROM), or a flash memory. The volatile memory may be a random access memory (RAM), used as an external cache. By way of an example but not limitative descriptions, random access memories (RAM) in many forms may be used, for example, a static random access memory (static RAM, SRAM), a dynamic random access memory (DRAM), a synchronous dynamic random access memory (SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or some of the foregoing embodiments may be implemented by software, hardware (for example, circuit), firmware, or any combination thereof. When software is used to implement embodiments, the foregoing embodiments may be implemented completely or partially in a form of a computer program product. The computer program product includes one or more computer instructions or computer programs. When the computer instructions or the computer programs are loaded and executed on a computer, the procedure or functions according to embodiments are all or partially generated. The computer may be a general-purpose computer, a dedicated computer, a computer network, or other programmable apparatuses. The computer instructions may be stored in a non-transitory computer-readable storage medium or may be transmitted from a non-transitory computer-readable storage medium to another non-transitory computer-readable storage medium. For example, the computer instructions may be transmitted from a website, computer, server, or data center to another website, computer, server, or data center in a wired (for example, infrared, radio, or microwave) manner. The non-transitory computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It may be understood that the term “and/or” describes only an association relationship between associated objects and represents that three relationships may exist. For example, A and/or B may represent the following three cases: only A exists, both A and B exist, and only B exists, where A and B may be singular or plural. In addition, the character “/” may indicate an “or” relationship between the associated objects, but may also indicate an “and/or” relationship. For details, refer to the context for understanding.

In the embodiments, “at least one” means one or more, and “a plurality of” means two or more. “At least one of the following items (pieces)” or a similar expression thereof means any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural.

It may be understood that sequence numbers of the foregoing processes do not mean execution sequences in various embodiments. The execution sequences of the processes may be determined based on functions and internal logic of the processes, and should not be construed as any limitation on the implementation processes of embodiments.

A person of ordinary skill in the art may be aware that, in combination with the examples described in embodiments, units and algorithm steps or operations may be implemented by electronic hardware or a combination of computer software and electronic hardware. Whether the functions are performed by hardware or software depends on particular applications and design constraints of the solutions. A person skilled in the art may use different methods to implement the described functions for each particular application, but it should not be considered that the implementation goes beyond the scope of the embodiments.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments, it should be understood that the system, apparatus, and method may be implemented in other manners. For example, the described apparatus embodiments are examples. For example, division into the units is logical function division and may be other division during implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, for example, may be located in one place, or may be distributed on a plurality of network units. Some or all of the units may be selected based on requirements to achieve the objectives of the solutions of embodiments.

In addition, functional units in the embodiments may be integrated into one processing unit, or each of the units may exist alone physically, or two or more units are integrated into one unit.

When the functions are implemented in the form of a software functional unit and sold or used as an independent product, the functions may be stored in a non-transitory computer-readable storage medium. Based on such an understanding, the solutions of the embodiments, or the part contributing to the conventional technology, or some of the solutions may be implemented in a form of a software product. The computer software product is stored in a storage medium, and includes several instructions for instructing a computer device (which may be a personal computer, a server, or a network apparatus) to perform all or some of the steps or operations of the method described in embodiments. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of the embodiments, but are not intended as limiting. Any variation or replacement readily figured out by a person skilled in the art shall fall within the scope of the embodiments.

1. A method, comprising:
obtaining a compensation coefficient, wherein the compensation coefficient is determined based on information about a first signal sent by a first access network device, and the information about the first signal comprises at least one of a receive power of the first signal and an index corresponding to the first signal; and
sending a second signal to a second access network device based on the compensation coefficient, wherein a transmit power of the second signal is determined based on the compensation coefficient.

2. The method according to claim 1, wherein the transmit power of the second signal is determined based on a maximum transmit power of a terminal apparatus and the compensation coefficient.

3. The method according to claim 2, wherein the transmit power of the second signal is determined based on the maximum transmit power of the terminal apparatus, the compensation coefficient, and a power boost step, or the transmit power of the second signal is determined based on the maximum transmit power of the terminal apparatus, the compensation coefficient, and a first power offset, or the transmit power of the second signal is determined based on the maximum transmit power of the terminal apparatus, the compensation coefficient, a power boost step, and a first power offset; and
the power boost step is a power increased during retransmission of the second signal, and the first power offset is determined based on service information of the terminal apparatus.

4. The method according to claim 3, wherein the transmit power of the second signal is expressed as:
P=min{P_{CMAX},α₁·P_{CMAX}+Δ₁+Δ₂}, wherein
P is the transmit power of the second signal, P_{CMAX} is the maximum transmit power of the terminal apparatus, α₁ is the compensation coefficient, Δ₁ is the power boost step, Δ₂ is the first power offset, and min{P_{CMAX},α₁·P_{CMAX}+Δ₁+Δ₂} represents selecting a smaller value from P_{CMAX} and α₁·P_{CMAX}+Δ₁+Δ₂.

5. The method according to claim 1, wherein the transmit power of the second signal is determined based on a signal receive power expected by the second access network device, a path loss between a terminal apparatus and the first access network device, and the compensation coefficient.

6. The method according to claim 5, wherein the transmit power of the second signal is determined based on the signal receive power expected by the second access network device, the path loss, the compensation coefficient, and a power boost step, or the transmit power of the second signal is determined based on the signal receive power expected by the second access network device, the path loss, the compensation coefficient, and a first power offset, or the transmit power of the second signal is determined based on the signal receive power expected by the second access network device, the path loss, the compensation coefficient, and a first adjustment amount, or the transmit power of the second signal is determined based on the signal receive power expected by the second access network device, the path loss, the compensation coefficient, a power boost step, and a first power offset, or the transmit power of the second signal is determined based on the signal receive power expected by the second access network device, the path loss, the compensation coefficient, a power boost step, and a first adjustment amount, or the transmit power of the second signal is determined based on the signal receive power expected by the second access network device, the path loss, the compensation coefficient, a first power offset, and a first adjustment amount, or the transmit power of the second signal is determined based on the signal receive power expected by the second access network device, the path loss, the compensation coefficient, a power boost step, a first power offset, and a first adjustment amount; and
the power boost step is a power increased during retransmission of the second signal, the first power offset is determined based on service information of the terminal apparatus, and the first adjustment amount is a power adjustment amount related to frequency domain resource allocation and link adaptation that correspond to the second signal.

7. The method according to claim 6, wherein the transmit power of the second signal is expressed as:
P=min{P_{CMAX},Pₑ+α₂·PL+Δ₁}, wherein
P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step, and min{P_{CMAX},Pₑ+α₂·PL+Δ₁} represents selecting a smaller value from P_{CMAX} and Pₑ+α₂·PL+Δ₁.

8. The method according to claim 6, wherein the transmit power of the second signal is expressed as:
P=min{P_{CMAX},Pₑ+α₂·PL+Δ₁+Δ₂+10 log₁₀(2^{μ}·M_{RB})}, wherein
P is the transmit power of the second signal, P_{CMAX} is a maximum transmit power of the terminal apparatus, Pₑ is the signal receive power expected by the second access network device, α₂ is the compensation coefficient, PL is the path loss, Δ₁ is the power boost step, Δ₂ is the first power offset, 10 log₁₀(2^{μ}·M_{RB}) is the first adjustment amount, μ corresponds to a subcarrier spacing used for transmitting the second signal, M_{RB} is a quantity of resource blocks (RBs) occupied for transmitting the second signal, and min{P_{CMAX},Pₑ+α₂·PL+Δ₁+Δ₂+10 log₁₀(2^{μ}·M_{RB})} represents selecting a smaller value from P_{CMAX} and Pₑ+α₂·PL+Δ₁+Δ₂+10 log₁₀(2^{μ}·M_{RB}).

9. The method according to claim 3, wherein the first power offset is determined based on a first correspondence between the service information of the terminal apparatus and a value of the first power offset.

10. The method according to claim 9, wherein the first correspondence is from the first access network device, and the first correspondence is carried in at least one of system information, a synchronization signal, or a radio resource control (RRC) message; or
the first correspondence is protocol-predefined.

11. The method according to claim 1, wherein obtaining the compensation coefficient comprises:
determining the compensation coefficient based on a second correspondence and the information about the first signal, wherein the second correspondence is a correspondence between a value range of the receive power of the first signal and a value of the compensation coefficient, or the second correspondence is a correspondence between the index corresponding to the first signal and a value of the compensation coefficient, or the second correspondence is a correspondence between a value range of the receive power of the first signal, the index corresponding to the first signal, and a value of the compensation coefficient.

12. The method according to claim 11, wherein the second correspondence is from the first access network device, and the second correspondence is carried in at least one of system information, a synchronization signal, or a radio resource control (RRC) message; or
the second correspondence is protocol-predefined.

13. The method according to claim 1, wherein the first access network device and the second access network device are a same device, and obtaining the compensation coefficient comprises:
receiving a secondary synchronization signal (SSS) sent by the first access network device; and
determining the compensation coefficient based on a signal receive power of the SSS.

14. The method according to claim 1, wherein the first access network device and the second access network device are a same device, and the value of the compensation coefficient is inversely correlated with a value of the receive power of the first signal.

15. The method according to claim 1, wherein a cell of the first access network device and a cell of the second access network device are neighboring cells of each other, or the first access network device is a macro base station and the second access network device is a micro base station of the macro base station; and obtaining the compensation coefficient comprises:
receiving a secondary synchronization signal (SSS) of the first access network device; and
determining the compensation coefficient based on a signal receive power of the SSS and an index corresponding to the SSS, or an index corresponding to the SSS.

16. The method according to claim 1, wherein the transmit power of the second signal is less than or equal to the maximum transmit power of the terminal apparatus.

17. A communication apparatus, comprising at least one processor, wherein the at least one processor is configured to read an instruction in a memory, and
obtain a compensation coefficient, wherein the compensation coefficient is determined based on information about a first signal sent by a first access network device, and the information about the first signal comprises at least one of a receive power of the first signal and an index corresponding to the first signal; and
send a second signal to a second access network device based on the compensation coefficient, wherein a transmit power of the second signal is determined based on the compensation coefficient.

18. The apparatus according to claim 17, wherein the transmit power of the second signal is determined based on a maximum transmit power of the apparatus and the compensation coefficient.

19. The apparatus according to claim 18, wherein the transmit power of the second signal is determined based on the maximum transmit power of the apparatus, the compensation coefficient, and a power boost step, or the transmit power of the second signal is determined based on the maximum transmit power of the apparatus, the compensation coefficient, and a first power offset, or the transmit power of the second signal is determined based on the maximum transmit power of the apparatus, the compensation coefficient, a power boost step, and a first power offset; and
the power boost step is a power increased during retransmission of the second signal, and the first power offset is determined based on service information of the apparatus.

20. A non-transitory computer-readable storage medium, comprising executable instructions, wherein the executable instructions, when executed by a computer, cause the computer to:
obtain a compensation coefficient, wherein the compensation coefficient is determined based on information about a first signal sent by a first access network device, and the information about the first signal comprises at least one of a receive power of the first signal and an index corresponding to the first signal; and
send a second signal to a second access network device based on the compensation coefficient, wherein a transmit power of the second signal is determined based on the compensation coefficient.
